(19) United States
(12) Patent Application Publication
(10) Pub. No.: US 2010/0088699 A1
(43) Pub. Date: Apr. 8, 2010

(54) VIRTUAL MACHINE OPERATION SYSTEM, VIRTUAL MACHINE OPERATION METHOD AND PROGRAM

(76) Inventor: Takayuki Sasaki, Tokyo (JP)

Correspondence Address: Mr. Jackson Chen, 6535 N. STATE HWY 161, IRVING, TX, 75039, US

(21) Appl. No.: 12/532,181

(22) PCT Filed: Dec. 14, 2007
(86) PCT No.: PCT/JP2007/074088

§ 371 Date: Sep. 21, 2009

(30) Foreign Application Priority Data
Mar. 27, 2007 (JP) 2007-081014

(51) Int. Cl. G06F 9/455; G06F 21/22; G06F 9/46; G06F 9/445; G06F 15/16

(52) U.S. Cl. 718/1; 717/177; 709/203

(57) ABSTRACT

It makes possible to accomplish by distributing only a partial disk image to be substituted among three areas in the disk image area of a virtual machine image, i.e., the OS area, the application area, and the user data area. A virtual machine image generation means 102 generates a virtual machine image by combining a device configuration file, a virtual device configuration file, and three disk images (OS disk image, provisioning disk image, and user data disk image) stored in a virtual machine component storage means 101. A virtual machine image distribution means 103 distributes a virtual machine image generated by the virtual machine image generation means 102. A disk map generation means 106 generates a map of a write protection area and a map of an area where collection is carried out.

### TECHNICAL FIELD

The present invention relates a virtual machine operation system, a virtual machine operation method and a program, in particular, to a server device, a client device, a virtual machine operation system, a virtual machine operation method, a virtual machine image distribution program and a virtual machine execution program capable of securely executing a virtual machine image and collecting user data.

### BACKGROUND ART

There has been a virtual machine technology which makes it possible that a certain information processing device virtually operates another information processing device of a different type (e.g., a different operating system (OS)). According to the virtual machine technology, it is possible to operate, for example, Linux (registered trademark) in a window in the operating environment of Windows (registered trademark). According to the virtual machine technology, since a different OS can operates in a personal computer in which a certain OS is installed, the development efficiency and the like of an application program (hereinafter called “application”) which can operates in the different OS is increased.

Non-patent literature 1 describes software “VMware ACE (registered trademark of VMWare, Inc.)” capable of creating a virtual machine environment. In VMware ACE, an administrator sets up a disk encryption of a virtual machine of and log-in setting or the like for a virtual machine, and generates a virtual device configuration file. Next, the administrator installs an OS and an application in the disk image, and generates a virtual machine image by combining the virtual device configuration file and the disk image. Next, that virtual machine image is converted into a package in the MSI (Microsoft Installer) format. Finally, that package is delivered to a client machine (hereinafter called “client”) in a CD or a DVD, or delivered to a client through a communication network. A user installs the virtual machine image by using the delivered package.

Technical terms relating to the virtual machine technology used in the specification of the present application are defined hereinafter. A virtual machine is a server, a personal computer (PC), or a mobile information terminal emulated on a physical machine (real machine). A virtual device is an emulated device such as a virtual memory, a virtual disk, and a virtual network card. The configuration of a virtual device possessed by a virtual machine is recorded in a configuration file (virtual machine configuration file) written in a predefined format. The contents of the virtual disk are recorded in a file called “disk image”. In the specification of the present application, an OS disk image is an image in which an OS is installed.

A provisioning disk image means a disk image in which an application (including security middleware) is installed. A user disk image is a disk image in which user-created data is recorded.

A virtual machine is a combination of a virtual device configuration file, an OS disk image, a provisioning disk image, and a user data disk image.

Non-Patent literature 2 discloses a system in which a package is selected by a GUI and then an installer automatically installs applications in a disk image, and therefore the disk image can be easily created.

Non-patent literature 3 shows a system capable of speedy constructing cluster in which a number of applications which the administrator needs to install additionally can be lessen, by examining frequently-used applications statistically and generating the disk image automatically in which the frequently-used applications are installed in advance.

According to virtual machine image distribution, Patent literature 1 discloses a system that performs disk image distribution by copying disk images from a computer having a plurality of disk images to clients. Patent literature 2 discloses a system that is modified from the system disclosed in Patent literature 1 such that portions of other disk images are copied in advance in free space of the disk so that the introduction of a virtual machine image is performed faster. Patent literature 3 discloses a distribution system that performs migration of a virtual machine without making a direct copy of a disk image in a client by using a storage area network (SAN) and thereby using a network-based file system.

In general, the execution means of a virtual machine firstly generates a virtual device in accordance with a device configuration written in a virtual device configuration file. In the virtual device, the contents of the virtual disk are generated based on a disk image. After that, when the OS on the virtual machine issues an input/output event to the virtual disk, the execution means of the virtual machine image performs data inputting/outputting corresponding to the input/output event for a disk image that is disposed in advance in a specific secondary storage device. For example, when the OS on a virtual machine generates a write event of a certain data for the virtual machine, the execution means of the virtual machine image writes the data into the image file.

### CITATION LIST

### Patent Literature 1

Japanese Unexamined Patent Application Publication No. 2002-278769 (paragraphs 0008-0015)

### Patent Literature 2

Japanese Unexamined Patent Application Publication No. 2006-163885 (paragraphs 0043-0050)

### Patent Literature 3

Japanese Unexamined Patent Application Publication No. 2006-244481 (paragraph 0005)

### Non Patent Literature 1

“VMWare ACE Manual for System Administrator”, [online], [retrieved on Feb. 14, 2007], Internet <URL: http://www.vmware.com/support/pubs/ace_pubs.html>, p. 17-30

### Non Patent Literature 2

Yasuhito TAKAMIYA, Yoshiaki SAKAE, Ikuhei YAMAGATA, and Satoshi MATSUOKA “A Flexible Configuration and Packaging Method for Cluster Installers” The Institute of Electronics, Information and Communication Engineers Technical Report, August 2005, VOL. 105, No. 225 (CPSY2005 7-14), p. 19-24

### Non Patent Literature 3

Hideo NISHIMURA, Hidemoto NAKADA, and Satoshi MATSUOKA “Virtual Cluster with Virtual Machines and Virtual Network” Information Processing Society of Japan Technical Report, Aug. 1, 2006, Vol. 2006 No. 87 (2006-HPC-103), p. 73-78

### DISCLOSURE OF INVENTION

### Technical Problem

Patent literatures 1 to 3 disclose distribution techniques of disk images or the likes. However, in a cace where a virtual machine image including a disk image in which an OS and an application is installed is distributed to a client in order to construct a virtual machine in the client, when update or the like occurs in the OS or the application, the whole virtual disk image, which typically in the order of several G-bytes to several tens G-bytes, has to be redistributed even if it requires only a partial modification of the disk image in the order of several M-bytes.

Furthermore, even if it is desired to prohibit the re-writing of the OS or standard applications as countermeasures against internet worms and malicious users, conventional virtual machine execution means cannot prohibits the re-writing to disk image areas where the OS and applications are recorded.

Furthermore, even if it is desired to collect only user data created on the virtual machine in a client that is the destination of the virtual machine image distribution, all three areas in the disk image area, i.e., the OS area, the application area, and the user data area have to be collected.

Accordingly, an object of the present invention is to provide a virtual machine operation system, a virtual machine operation method and a program in which, when a portion of a virtual machine image is to be modified, it is unnecessary to redistribute the whole virtual disk image and it is accomplished by distributing only a partial disk image to be substituted among the three areas in the disk image area, i.e., the OS area, the application area, and the user data area. Further, another object of the present invention is to prevent the distributed OS and application from being modified during the virtual machine execution. Furthermore, another object of the present invention is to make it possible to collect only user data from the destination of the virtual machine image distribution.

### Technical Solution

A virtual machine operation system in accordance with the present invention is a virtual machine operation system wherein a server device (e.g., serve 100, 100B, 100C, or 100D) includes: virtual machine image generation means that generates a virtual machine image in such a manner that an operating system disk image area, an application disk image area, and a user data disk image area are distinguishable; and virtual machine image distribution means that distributes a virtual machine image generated by the virtual machine image generation means to a second device (e.g., client 110, 110C, or 100E), and the second device includes virtual machine image execution means that executes a virtual machine based on the virtual machine image distributed from the virtual machine image distribution means.

A virtual machine operation system in accordance with another aspect of the present invention is a virtual machine operation system wherein a server device includes: virtual machine image generation means that generates a virtual machine image including a disk image area including a data write protection area (e.g., OS disk image area or provisioning disk image area, i.e., application disk image area) and a user data disk image area; disk map generation means that generates a disk map capable of specifying the data write protection area; and virtual machine image distribution means that distributes a virtual machine image generated by the virtual machine image generation means and a disk map generated by the disk map generation means to a second device, and the second device includes: virtual machine image execution means that executes a virtual machine based on the virtual machine image distributed from the virtual machine image distribution means; and input/output monitoring means that specifies a data write protection area in the disk map, monitors a write event by the virtual machine image execution means, and prohibits data writing to the data write protection area.

A virtual machine operation system in accordance with another aspect of the present invention is a virtual machine operation system wherein a server device includes: virtual machine image generation means that generates a virtual machine image in such a manner that a user data disk image area and another disk image area (e.g., OS disk image area or provisioning disk image area, i.e., application disk image area) are distinguishable; disk map generation means that generates a disk map capable of specifying a data collection area in the user data disk image area; and virtual machine image distribution means that distributes a virtual machine image generated by the virtual machine image generation means and a disk map generated by the disk map generation means to a second device, and the second device includes: virtual machine image execution means that executes a virtual machine based on the virtual machine image distributed from the virtual machine image distribution means; and user data transmission means that specifies the data collection area in the disk map and transmits data in the data collection area to the server device.

A virtual machine operation system in accordance with still another aspect of the present invention is a virtual machine operation system wherein a server device includes: user authentication means that authenticates a user of a second device; virtual machine image generation means that, when the user authentication means succeeds in authenticating a user of the second device, generates a virtual machine image in accordance with the user of the second device in such a manner that an operating system disk image area, an application disk image area, and a user data disk image area are distinguishable; and virtual machine image distribution means that distributes a virtual machine image generated by the virtual machine image generation means to the second device, and the second device includes virtual machine image execution means that executes a virtual machine based on the virtual machine image distributed from the virtual machine image distribution means.

### Advantageous Effects

A first advantageous effect is that update of the OS and applications can be carried out efficiently. This is because the virtual machine image distribution means distributes a disk image capable of specifying the necessary area for the update.

A second advantageous effect is that the OS and security middleware can be protected from malicious users and software. This is because overwriting to data write protection areas of the distributed OS and security middleware and the like is prohibited by the disk map generation means that generates a disk map (write protection map) capable of specifying the data protection areas and the input/output monitoring means that operates according to the write protection map.

A third advantageous effect is that user data can be collected efficiently. This is because only the area where user data is recorded is collected by the disk map generation means that generates a map of date to be collected and the user data transmission means that transmits data according to the map of data to be collected.

A fourth advantageous effect is that user data can be collected without omission. This is because user data is never mixed into the areas where the OS and security middleware are recorded owing to the disk map generation means that generates a write protection map and the input/output monitoring means that operates according to the write protection map.

### BRIEF DESCRIPTION OF DRAWINGS

FIG. 1 is a block diagram illustrating a configuration of a virtual machine operation system in accordance with a first exemplary embodiment of the present invention;

FIG. 2 is an explanatory diagram showing relation between virtual machine image execution means and virtual machine image storage means;

FIG. 3 is a sequence diagram showing a virtual machine image distributing operation;

FIG. 4 is an explanatory diagram illustrating an example of a disk configuration;

FIG. 5 is an explanatory diagram showing an example of a disk map;

FIG. 6 is a flowchart showing a disk map generating operation in accordance with a first exemplary embodiment;

FIG. 7 is a flowchart showing a writing operation at a time when a virtual machine is executed;

FIG. 8 is a sequence diagram showing a writing operation at a time when the virtual machine is executed;

FIG. 9 is a sequence diagram showing a reading operation at a time when the virtual machine is executed;

FIG. 10 is a sequence diagram showing a user data collecting operation;

FIG. 11 is a flowchart showing operations in which user data is taken out as a file;

FIG. 12 is a block diagram illustrating a configuration of a server in accordance with a second exemplary embodiment of the present invention;

FIG. 13 is a sequence diagram showing a disk map generating operation in accordance with a second exemplary embodiment;

FIG. 14 is a flowchart showing a disk map generating operation in accordance with a second exemplary embodiment;

FIG. 15 is an explanatory diagram illustrating an example of a disk map in accordance with a second exemplary embodiment;

FIG. 16 is a sequence diagram showing operations for monitoring a read sector in accordance with a second exemplary embodiment;

FIG. 17 is a flowchart showing operations for monitoring the read sector in accordance with the second exemplary embodiment;

FIG. 18 is a block diagram illustrating a configuration of an information processing system in accordance with a third exemplary embodiment;

FIG. 19 is a sequence diagram showing operations for deleting the disk image in accordance with the third exemplary embodiment;

FIG. 20 is a block diagram illustrating a configuration of a server in accordance with a fourth exemplary embodiment of the present invention;

FIG. 21 is a block diagram illustrating a configuration of a virtual machine operation system in accordance with the fifth exemplary embodiment of the present invention;

FIG. 22 is a block diagram illustrating a configuration of a virtual machine operation system in accordance with a sixth exemplary embodiment of the present invention;

FIG. 23 is a sequence diagram showing operations at a time of log-in;

FIG. 24 is an explanatory diagram illustrating an example of a disk configuration;

FIG. 25 is an explanatory diagram illustrating an example of a disk configuration;

FIG. 26 is an explanatory diagram illustrating an example of a disk configuration;

FIG. 27 is an explanatory diagram illustrating an example of a configuration screen for file/partition/disk that is protected by an administration UI;

FIG. 28 is an explanatory diagram illustrating an example of a window for configuring data that is collected by an administration UI;

FIG. 29 is an explanatory diagram illustrating an example of a designation window for disk image deletion by an administration UI; and

FIG. 30 is an explanatory diagram illustrating an example of a disk image combination map.

### EXPLANATION OF REFERENCE

100, 1008, 100C, 100D, 100F SEVER
101 VIRTUAL MACHINE COMPONENT STORAGE MEANS
102 VIRTUAL MACHINE IMAGE GENERATION MEANS
103 VIRTUAL MACHINE IMAGE DISTRIBUTION MEANS
104 USER DATA RECEPTION MEANS
105 USER DATA STORAGE MEANS
106 DISK MAP GENERATION MEANS
107 VIRTUAL MACHINE IMAGE TEST MEANS
108 DELETE INSTRUCTION MEANS
109 ADMINISTRATION UI
1010 VIRTUAL MACHINE COMPONENT GENERATION MEANS
1011 USER AUTHENTICATION MEANS
1012 USER ADMINISTRATION MEANS
110, 110C, 110E, 110F CLIENT
111 VIRTUAL MACHINE IMAGE EXECUTION MEANS
112 INPUT/OUTPUT MONITORING MEANS
113 VIRTUAL MACHINE IMAGE STORAGE MEANS
114 USER DATA TRANSMISSION MEANS
115 VIRTUAL MACHINE IMAGE RECEPTION MEANS
116 IMAGE DELETE MEANS
117 VIRTUAL MACHINE REMOTE CONTROL MEANS
118 USER LOG-IN MEANS

### BEST MODES FOR CARRYING OUT THE INVENTION

Best modes for carrying out the present invention are explained hereinafter in detail with reference to the drawings.

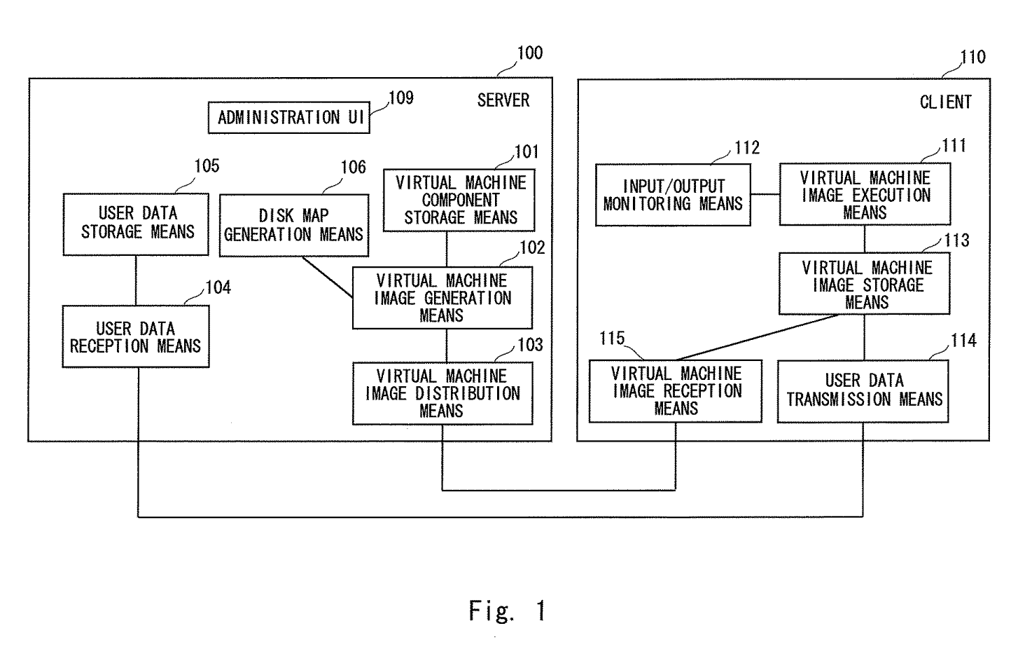

FIG. 1 is a block diagram illustrating a configuration of a virtual machine operation system in accordance with a first exemplary embodiment of the present invention (Exemplary Embodiment 1). The virtual machine operation system shown in FIG. 1 includes a server 100 and at least one client 110. Note that only one client 110 is shown in FIG. 1. Further, the server 100 and the client 110 transmit/receive data through a communication network such as the Internet.

The server 100 includes a virtual machine component storage means 101 that records a virtual device configuration file, an OS disk image in which an OS is installed, a provisioning disk image in which an application (including security middleware) is installed, and a user data disk image in which user data is recorded, a virtual machine image generation means 102 that generates a virtual machine image by combining a device configuration file, a virtual device configuration file, and three disk images (OS disk image, provisioning disk image, and user data disk image), all of which are stored in the virtual machine component storage means 101, a virtual machine distribution means 103 that distributes a virtual machine image generated by the virtual machine image generation means 102, an user data reception means 104 that receives user data, an user data storage means 105 that stores user data, disk map generation means 106 that generates a disk map, and an administration UI (User Interface) 109 that receives instructions from an administrator and reports to the administrator.

Further, the client 110 also includes virtual machine image execution means 111 that executes a virtual machine image, input/output monitoring means 112 that monitors inputs/outputs of the virtual machine image execution means 111, virtual machine image storage means 113 that has a storage area and stores a virtual machine image, user data transmission means 114 that transmits user data, and virtual machine image reception means 115 that receives a virtual machine image.

Operations of each means are described below.

The virtual machine component storage means 101 contains a virtual device configuration file, an OS disk image, a provisioning disk image, a user data disk image with regard to one or more than one virtual machine. The virtual machine component storage means 101 delivers the respective disk images and the virtual device configuration file to the virtual machine image generation means 102 in response to a request from the virtual machine image generation means 102.

The virtual machine image generation means 102 receives three disk images and a virtual device configuration file from the virtual machine component storage means 101, and generates a virtual machine image by combining the respective disk images and the virtual device configuration file. The virtual machine image distribution means 103 distributes a virtual machine generated by the virtual machine image generation means 102 to the virtual machine image reception means 115 of the client 110.

The user data reception means 104 receives user data from the user data transmission means 114 of the client, and checks the signature. The signature indicates which client the user data belongs to. The user data storage means 105 receives user data from the user data reception means 104, and stores the user data. The disk map generation means 106 generates a map of area where writing is prohibited and a map of area where collection is carried out.

The administration UI 109 receives an instruction from an administrator, issues a command to each means, receives a report from each means, and displays it in the display unit.

The virtual machine image execution means 111 executes a virtual machine based on a virtual machine image, and carries out inputting/outputting for the disk image during the execution. The input/output monitoring means 112 monitors inputting/outputting for a disk image carried out by the virtual machine, and blocks writing to sectors or disks defined in the write protection map. The virtual machine image storage means 113 receives a virtual machine image from the virtual machine image reception means 115, and stores it in the storage area. The user data transmission means 114 generates a signature of user data, and outputs the user data and the signature to the user data reception means 104. The virtual machine image reception means 115 receives a virtual machine image from the virtual machine image distribution means 103. The virtual machine image storage means 113 stores a virtual machine image.

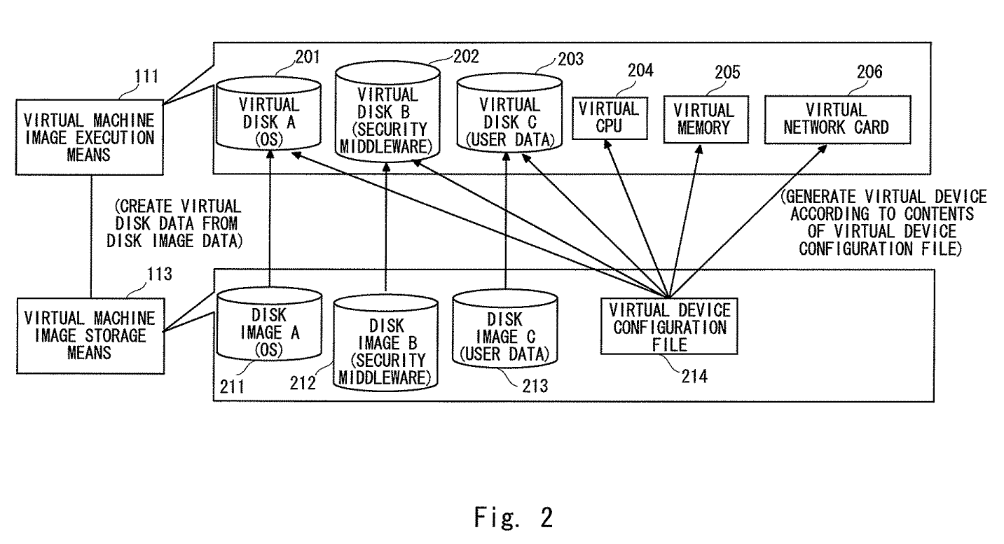

FIG. 2 is an explanatory diagram showing relation between the virtual machine image execution means 111 and the virtual machine image storage means 113 in the client 110. As shown in FIG. 2, an OS disk image (disk image A) 211, a provisioning disk image (disk image B) 212 including security middleware, a user data image (disk image C) 213, and a virtual device configuration file 214, all of which are received from the server 100, are stored in the virtual machine image storage means 113.

The virtual machine image execution means 111 generates a virtual CPU 204, a virtual memory 205, and a virtual network card 205 and the like of the virtual machine according to the contents of the virtual device configuration file 214 stored in the virtual machine image storage means 113. Further, it also creates data of a virtual disk (virtual disk A) 201 including the OS of the virtual machine and data of a virtual disk (virtual disk B) 202 including security middleware and the like from the disk images A, B and C, and also creates a virtual disk (virtual disk C) 203 in which user data is stored.

Next, the overall operation of this exemplary embodiment is explained hereinafter.

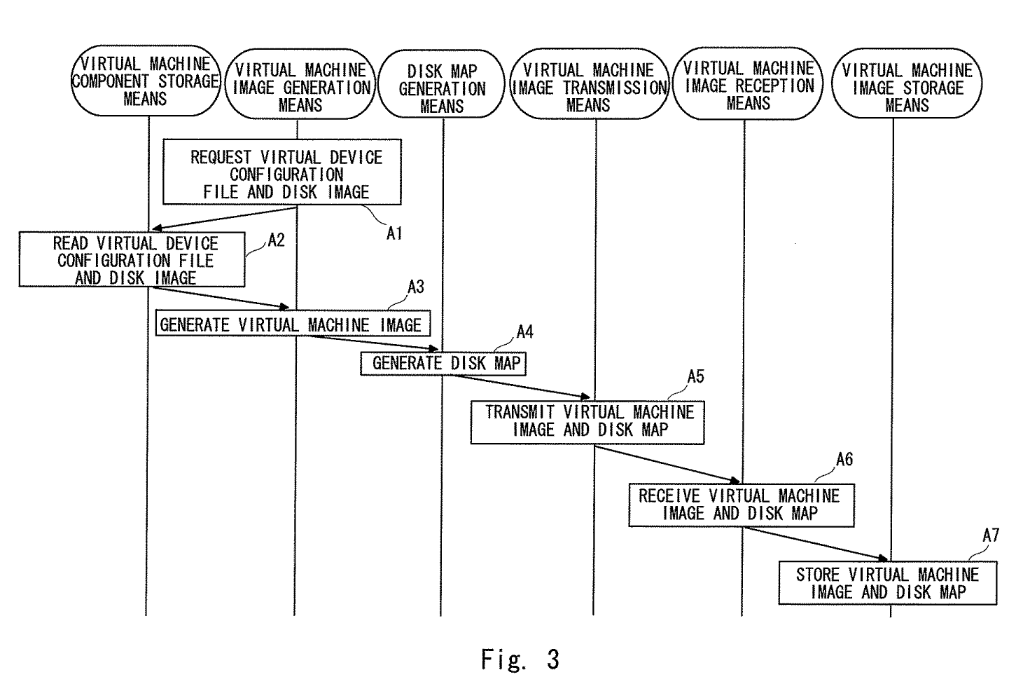

Firstly, generation and distribution of a virtual machine image are explained with reference to a sequence diagram of FIG. 3. The virtual machine image generation means 102 requests a virtual device configuration file and disk images of a virtual machine to be generated from the virtual machine component storage means 101 (step A1). The disk images to be requested are an OS disk image, a provisioning disk image, and a user data disk image. The virtual machine component storage means 101 reads the requested virtual device configuration file and disk images from the storage unit (step A2), and delivers them to the virtual machine image generation means 102. The virtual machine image generation means 102 generates a virtual machine image by combining the virtual device configuration file, OS disk image, provisioning disk image, and user data disk image (step A3).

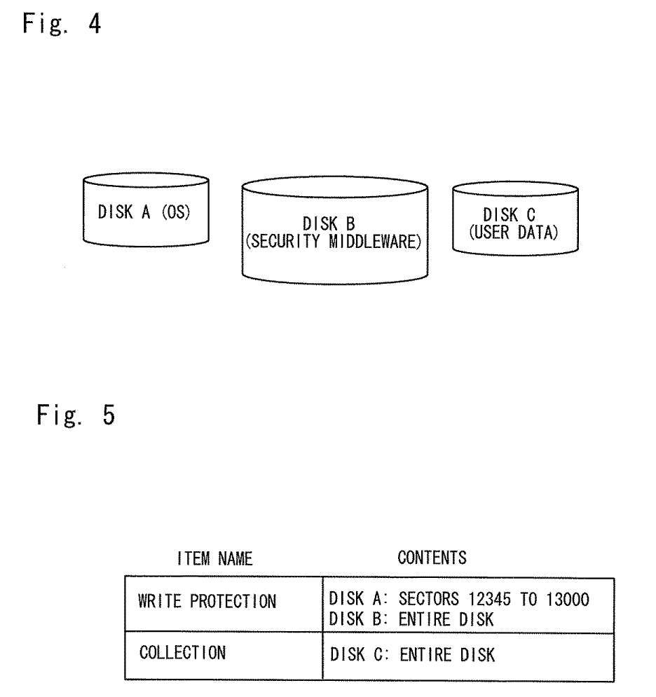

For example, as shown in FIG. 4, it combines an OS disk image (disk A), a provisioning disk image (disk B) in which security middleware and the like are installed, and a user data disk image (disk C) in a state where only a partition is created. An independent disk image or a differential disk image in which difference of the disk image having an OS or security middleware or the like recorded therein is used as the user data disk image.

The disk map generation means 106 generates a disk map (step A4). The disk map includes, at least, a write protection item specifying write protection areas in the OS disk image area and the provisioning disk image area, and a collection item specifying areas to be collected in the user data disk image area. FIG. 5 shows an example of a disk map. In the example shown in FIG. 5, sectors 12345 to 13000 of the disk A and the entire area of the disk B are specified in the write protection item. Further, the entire area of the disk C is specified in the collection item.

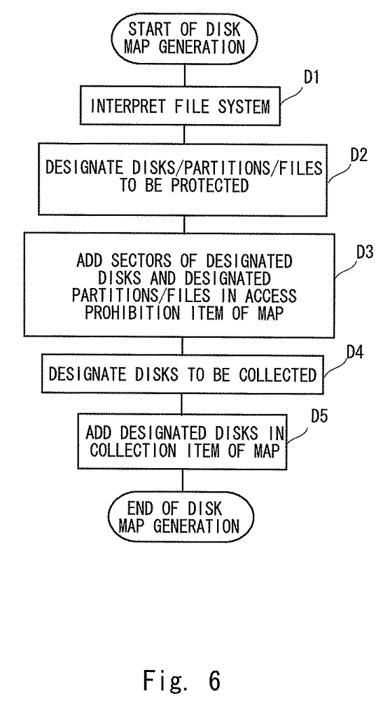

Next, operations of the disk map generation means 106 are explained with reference to a flowchart of FIG. 6. The disk map generation means 106 obtains information about partitions and files by interpreting a disk image in the virtual machine (step D1). The information about files and partitions is displayed by the administration UI 109, and an administrator designates disks, partitions, and files that he/she wants to protect (step D2). The disk map generation means 106 adds sectors corresponding to designated partitions and files in the write protection item of the disk map (step D3). If writing is prohibited to the entire disk of one virtual disk, the disk may be designated instead of designating sectors. Further, disks or partitions that are to be collected at a time of the user data collection is specified in the collection item of the map.

Upon generation of a disk map, the virtual machine image distribution means 103 transmits the virtual machine image and the disk map to the client 110 (step A5). In the client 110, the virtual machine image reception means 115 receives the virtual machine image and the disk map (step A6). Then, it outputs the received virtual machine image and disk map to the virtual machine image storage means 113. The virtual machine image storage means 113 stores the virtual machine image and disk map (step A7).

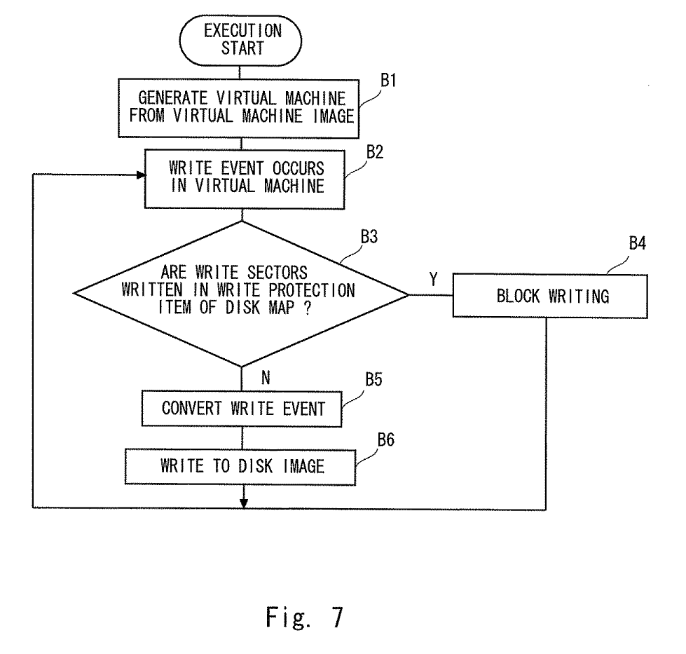

Next, execution of a virtual machine is explained hereinafter. Firstly, operations of the client 110 at a time when a read event and a write event to a disk in the virtual machine occur are explained hereinafter with reference to a flowchart of FIG. 7.

The virtual machine image execution means 111 generates a virtual machine from the virtual machine image (step B1). When a write event to a disk occurs, the input/output monitoring means 112 checks whether writing is prohibited or not in the disk map (steps B2 and B3). If the writing is prohibited, the input/output monitoring means 112 blocks the writing (step B4). If the writing is not prohibited, the virtual machine image execution means 111 converts the write event to the virtual disk into a write event to a disk image. The write event to a virtual disk is, for example, an event including an SCSI command to a virtual disk, and the write event to a disk image is, for example, an event including a write command to a disk image existing on a real disk. Finally, the virtual machine image execution means 111 executes writing to an appropriate virtual machine image in the virtual machine image storage means 113 (step B6).

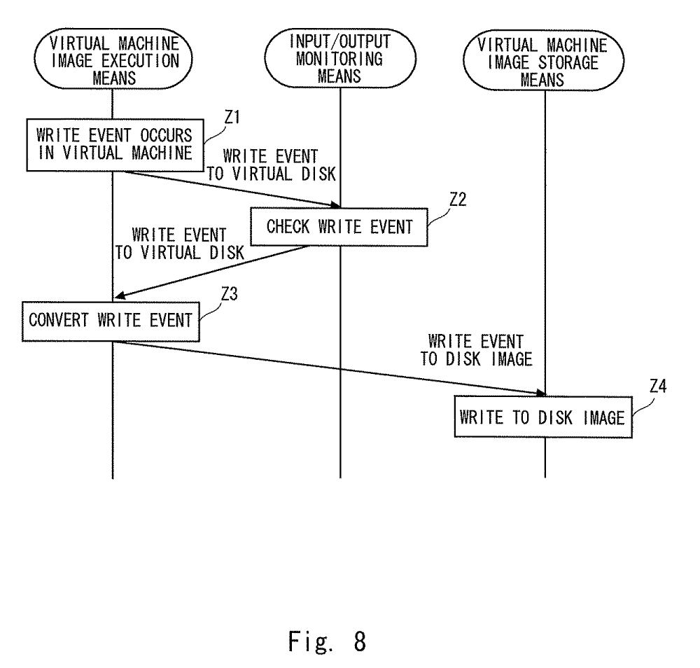

To explain the writing operation more clearly, supplementary explanation is made hereinafter with reference to FIG. 8. FIG. 8 is a sequence diagram showing operations of the virtual machine image execution means 111 and the like when the writing is not blocked in the above-described write event. The event that is delivered from the virtual machine image execution means 111 to the input/output monitoring means 112 when a write event to a virtual disk occurs in the virtual machine that is being executed by the virtual machine image execution means 111 (step Z1) is a write event to the virtual disk. The input/output monitoring means 112 checks whether the writing is prohibited or not for the write event (step Z2). In the example shown in FIG. 5, it is checked so that no user data is written to the areas where a portion of the OS and security middleware is recorded. The write event to the virtual disk that passed the check is converted into a write event to a disk image by the virtual machine image execution means 111 (step Z3), and is delivered to the virtual machine image storage means 113. The conversion of the write event is carried out, for example, by comparing sectors of the virtual disk in the SCSI command with a reference table in the disk image existing on the physical disk. The virtual machine image storage means 113 rewrites the stored disk image (step Z4).

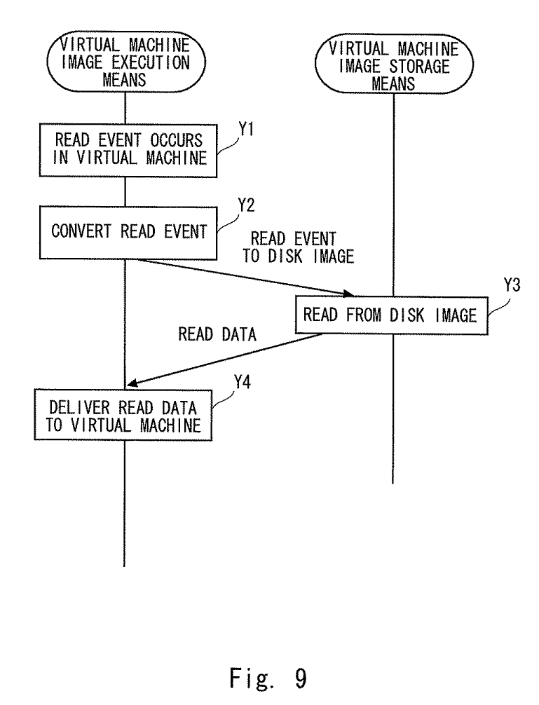

Operations at a time when a read event to a disk occurs in a virtual machine are explained hereinafter with reference to a sequence diagram of FIG. 9. When a read event occurs in the virtual machine image execution means 111 (step Y1), the virtual machine image execution means 111 converts the read event to the virtual disk into a read event to a disk image. The converting operation is similar to that in the writing operation. The virtual machine image storage means 113 reads a specified area of the disk image according to the read event (step Y3). The read data is delivered to the virtual machine image execution means 111. That is, data is returned to the virtual machine.

Next, user data collection is explained hereinafter with reference to a sequence diagram of FIG. 10. The virtual machine image storage means 113 reads a disk map (step C1). The read disk map is delivered to the user data transmission means 114. The user data transmission means 114 reads the collection item of the disk map (step C2), and requests a corresponding area from the virtual machine image storage means 113 (step C3). The virtual machine image storage means 113 reads the specified area in the disk image (step C4). The virtual machine image storage means 113 outputs the read data to the user data transmission means 114. The user data transmission means 114 generates, for the user data, a signature indicating that the user data belongs to the client 110 (step C5). Then, the user data transmission means 114 transmits the user data and the signature to the server 100 (step C5). In the server 100, the user data reception means 104 receives the user data and the signature (step C7). The user data reception means 104 checks the validity of the signature (step C8). If the user data reception means 104 determines that the signature is valid, it delivers the received data to the user data storage means 105. The user data storage means 105 stores the received data in the storage unit (step C9).

If the user data reception means 104 determines that the signature is invalid in the step C8, the administration UI 109 presents a choice of options, such as discarding the user data or storing the user data regardless of the signature.

This exemplary embodiment can provide the following advantageous effects. That is, the OS and security middleware are recorded in the write protection item of the disk map, and thereby it is configured such that no data is written over those areas where the OS and security middleware are recorded owing to the input/output monitoring means 112. As a result, the OS and security middleware can be protected.

Further, since it is configured that no user data can be written in the areas where the OS and security middleware are recorded in this exemplary embodiment, all the user data can be collected by collecting only the area where the user data is recorded. Furthermore, in this exemplary embodiment, since it is configured such that only user data is collected, the data traffic between the server 100 and the client 110 is small.

Note that although a method in which files and partitions are designated by an administrator using the administration UI 109 is adopted as a method for generating disk map generation in this exemplary embodiment, a disk map may be generated by automatically carrying out the designation with a rule set incorporated in the disk map generation means 106. Examples of the rule set include “to prohibit writing to disks of /boot and /bin in the case of an OS based on “UNIX (registered trademark)”, and “to designate a partition including /home as an area where collection is carried out in the case of an OS based on “UNIX (registered trademark)”.

Further, although the input/output monitoring means 112 performs the operation to block writing to write protection sectors in this exemplary embodiment, it may, in addition to blocking writing, notify the administration UI 109 of the information that the writing was blocked so that the administration UI 109 can display the information.

Furthermore, although transmission/reception operations of a virtual machine image are shown as operations of the virtual machine image distribution means 103 and the virtual machine image reception means 115 in this exemplary embodiment, the virtual machine image distribution means 103 may, after the distribution of a virtual machine image, redistribute the disk image or distribute an additional disk image in response to an instruction from the administration UI 109 or a request from the virtual machine image reception means 115. With an operation like this, an administrator can distribute a patch and update the configuration. The disk image to be distributed may be an independent disk image or a differential disk image of an already-distributed disk image.

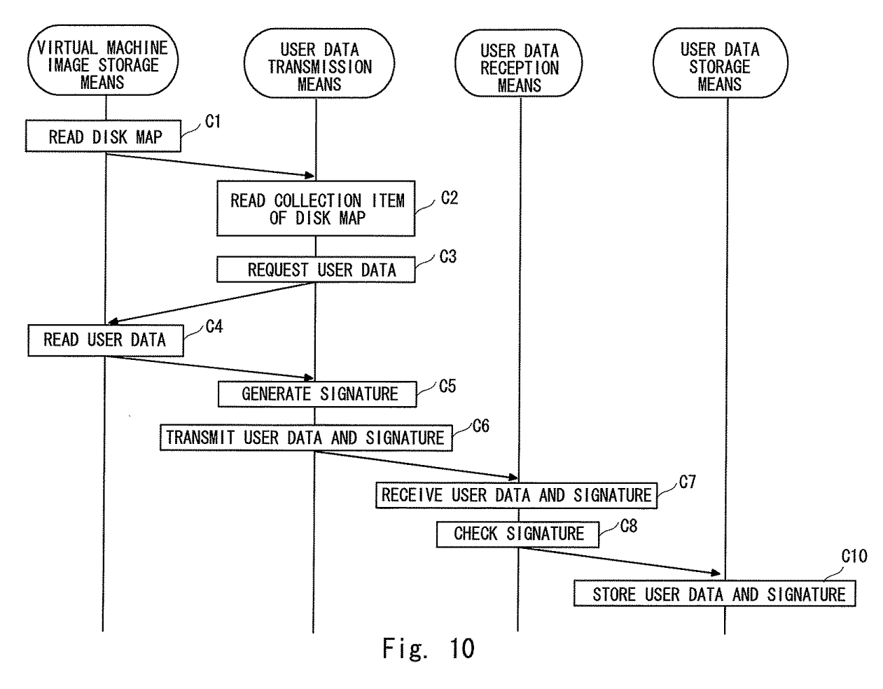

Although an operation in which user data is stored without any modification is explained as an operation of the user data storage means 105 in accordance with this exemplary embodiment, it may be provided with file extraction means so that the file extraction means can extract files from the user data. FIG. 11 is a flowchart showing operations in which file extraction means extracts files from user data. The file extraction means checks whether or not user data received from the client 110 by the user data reception means 104 includes a complete partition and thus can be interpreted as a file system (step G1). The reason why the check whether or not it includes a complete partition in the process of the step G1 must be carried out is that it does not necessarily include a complete partition because if a differential disk is used, only difference is recorded. If the partition is not complete, i.e., is a portion of the complete partition, the incomplete portion is complemented based on the disk image included in the virtual machine image distributed to the client (step G2). After that, the file extraction means interprets the file system (step G3). Then, it generates a file list from the interpreted file system, and an administrator designates files to be collected by using the administration UI 109 (step G4). The file extraction means extracts the designated files from the disk image (step G5).

Further, in this exemplary embodiment, an example where the virtual machine image generation means 102 uses an independent disk image or a differential disk image as a user data disk image is explained. Furthermore, a disk in which user data is written is shown as an example of contents written in the collection item of the map of the disk map generation means 106 (see FIG. 5). However, the virtual machine image generation means 102 may use a single disk as the disk to which an OS and security middleware and user data are recorded, divide it into partitions, and specify sectors of the partitions in which user data is written in the collection item of the map in the disk map generation means 106. If sectors of the partitions are specified in the collection item of the disk map, the user data transmission means 114 extracts these sectors of the partitions from the disk and transmits them to the user data reception means 104.

### Exemplary Embodiment 2

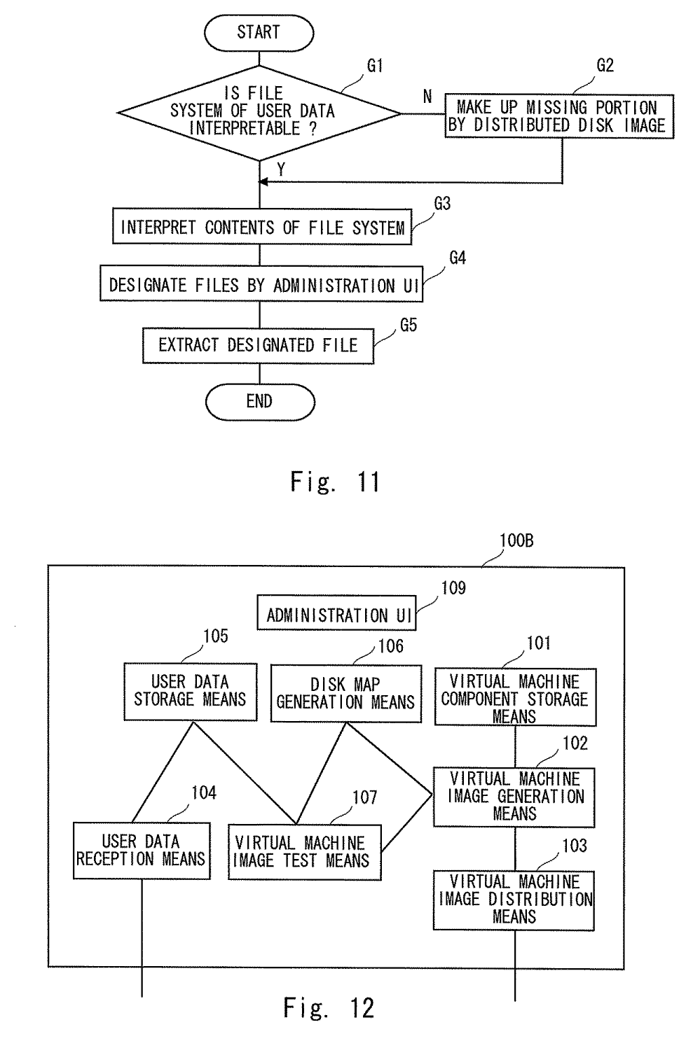

Next, a second exemplary embodiment of the present invention (Embodiment 2) is explained hereinafter with reference to the drawings. FIG. 12 is a block diagram illustrating a configuration of a server 1008 in accordance with a second exemplary embodiment. As shown in FIG. 12, the server 100B is different from the server 100 in accordance with a first exemplary embodiment in that the server 100B includes a virtual machine image test means 107. Note that the same signs are assigned to the same components as those in a first exemplary embodiment, and their detailed explanation is omitted. Further, a client in accordance with this exemplary embodiment is the same as the client 110 in a first exemplary embodiment, and therefore its explanation is also omitted.

The virtual machine image test means 107 receives a virtual machine image from the virtual machine image generation means 102 and executes a virtual machine. That is, it executes an OS and security middleware. The virtual machine image test means 107 is called from the user data storage means 105, and executes the virtual machine. The virtual machine image test means 107 delivers sector information that is read/written at a time of the execution of the virtual machine to the disk map generation means 106.

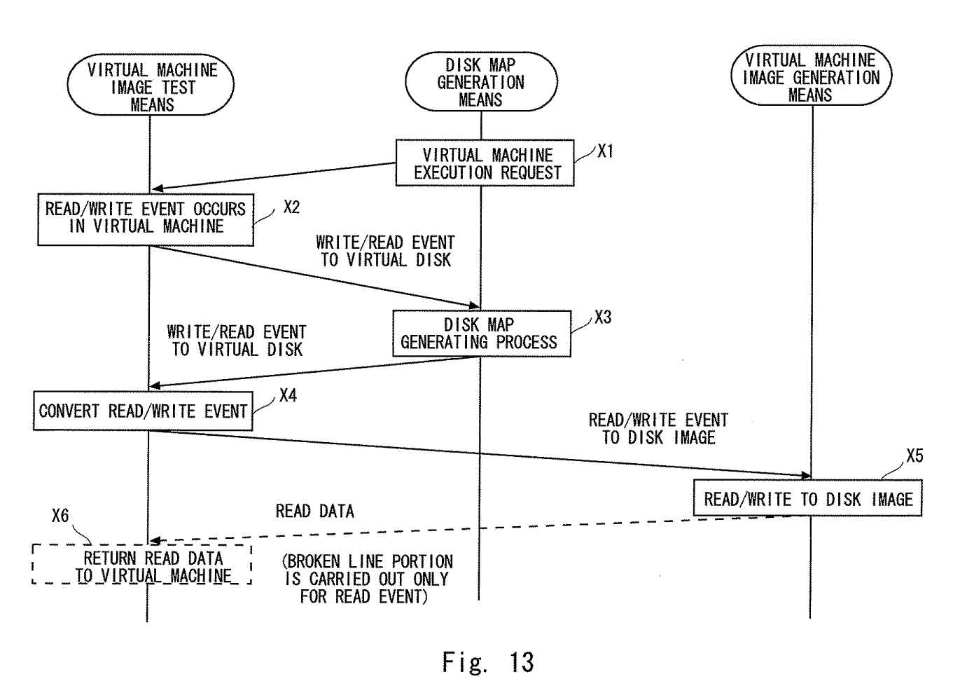

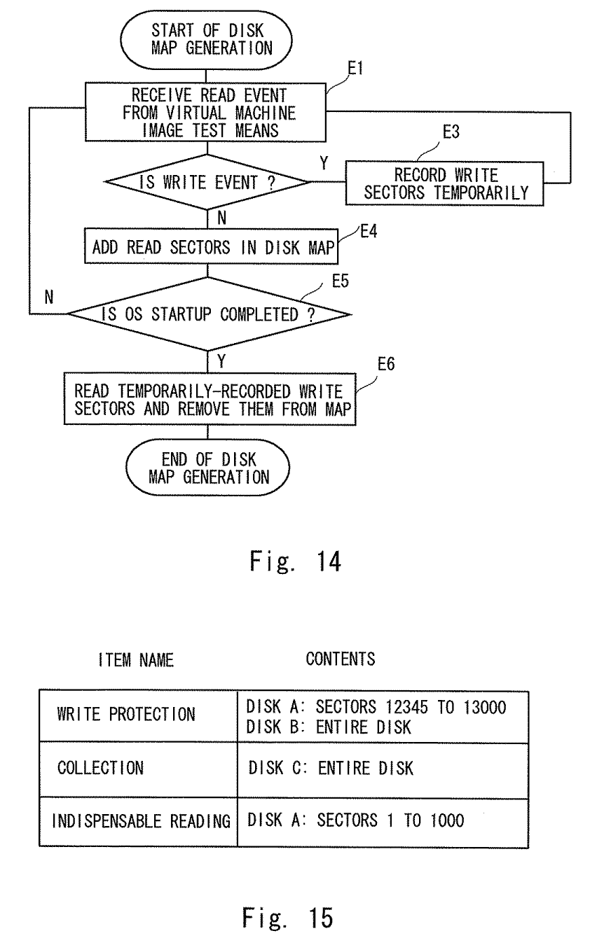

Next, operations of this exemplary embodiment are explained. FIGS. 13 and 14 are a sequence diagram and a flowchart, respectively, showing a disk map generating operation with regard to the write protection item in accordance with a second exemplary embodiment. Operations other than the disk map generation with regard to the write protection item are the same as those of a first exemplary embodiment, and therefore their explanation is omitted.

The overview of the operations of this exemplary embodiment is explained hereinafter with reference to FIG. 13. The disk map generation means 106 calls the virtual machine image test means 107 (step X1). The virtual machine image test means 107 reads a virtual machine image from the virtual machine image generation means 102 and executes a virtual machine (step X2). Input/output information of the virtual machine is delivered to the disk map generation means 106. The disk map generation means 106 generates a disk map (step X3). Further, the virtual machine image test means 107 converts an event to the virtual disk into an event to a disk image (step X4). Furthermore, the virtual machine image generation means 102 performs reading and writing for the disk image (step X5). If the event is a read event, the read data is delivered to the virtual machine image test means 107. That is, data that is read into the virtual machine is delivered to the virtual machine image test means 107 (step X6).

The operations of the disk map generation process (step X3) shown in FIG. 13 are explained in detail with reference to FIG. 14. Firstly, the disk map generation means 106 receives a read/write event from the virtual machine image test means 107 (step E1). The disk map generation means 106 determines whether the event is a read event or a write event (step E2). If it is a read event, sectors to be read are recorded in the write protection item of the disk map (step E4). If it is a write event, sectors to be written are temporarily recorded (step E3). The operations from the steps E1 to E5 are repeated until the startup of the OS is completed. If writing to sectors to which writing is performed by the OS is prohibited, the OS cannot operate properly. Therefore, sectors to which writing was performed are removed from the write protection item of the disk map by referring to the temporarily recorded write sectors (step E6). In a manner described above, areas from which the OS and security middleware read data during the execution of the OS and security middleware are defined as the areas to which writing is prohibited. Further, areas to which the OS and security middleware write data during the execution of the OS and security middleware are removed from the areas to which writing is prohibited.

Note that in a first exemplary embodiment, operations in which a file system of partitions of a disk is interpreted and user data is extracted as files are explained as operations of the user data storage means 105. However, in this exemplary embodiment, the user data storage means 105 may call the virtual machine image test means 107, reproduce the environment of the client 110 by combining a virtual machine image distributed to the client and a user data disk image collected from a user, and extract user data in the form of a file.

Further, an aspect in which a map indicating write protection sectors is generated has been shown as the disk map generation means 106 in accordance with this exemplary embodiment. However, in addition to the write protection item, sectors that have to be read without fail may be specified in an indispensable reading item of the disk map, and the input/output monitoring means 112 may monitor whether these sectors are read in the client 110. FIG. 15 shows an example of an indispensable reading item of a disk map. In this example, sectors 1 to 1000 of a disk A are specified as sectors that must be read without fail. The write protection item and the collection item are similar to those of FIG. 5. According to a configuration like this, it can ensure that, for example, a boot sequence that must be executed without fail is not bypassed. Further, it can also detect such a situation that no OS or the like exists in the sector in the client 110 where the OS or the like should exist, i.e., a situation where there is a possibility that the OS or the like is tampered.

The generation of an indispensable reading item of the map can be implemented, for example, by recoding read sectors in the disk map during the disk map generation process (step X3) shown in FIG. 13. That is, the process shown in FIG. 14 can be used as a generation process for an indispensable reading item of the map by removing the steps E3 and E6 and changing the step E4 to an operation for adding read sectors in the indispensable reading item of the disk map.

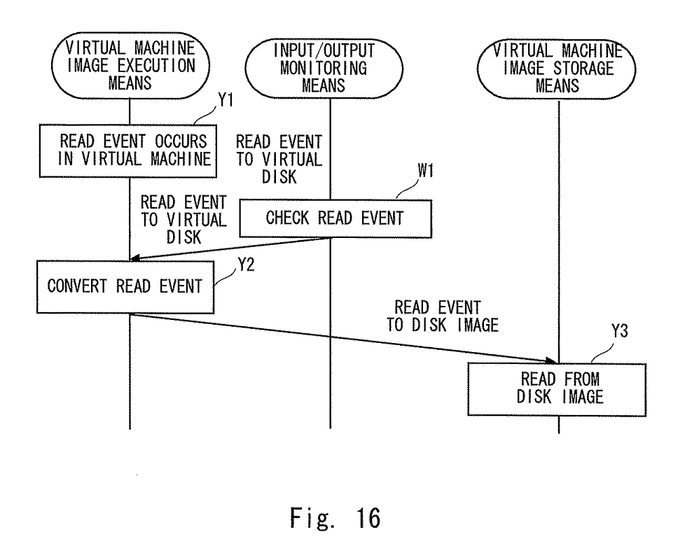

The overview of the operations of the client 110 is explained hereinafter with reference to a sequence diagram of FIG. 16. In this exemplary embodiment, a read event check for monitoring a read event (step W1) in addition to the operations in accordance with a first exemplary embodiment (see FIG. 9) are carried out in the client 110. Although the input/output monitoring means 112 does not monitor any read event in a first exemplary embodiment, the input/output monitoring means 112 also monitors a read event to confirm that sectors specified in the indispensable reading item of the disk map are read in this exemplary embodiment. Processes other than those in the step W1 are similar to those shown in FIG. 9.

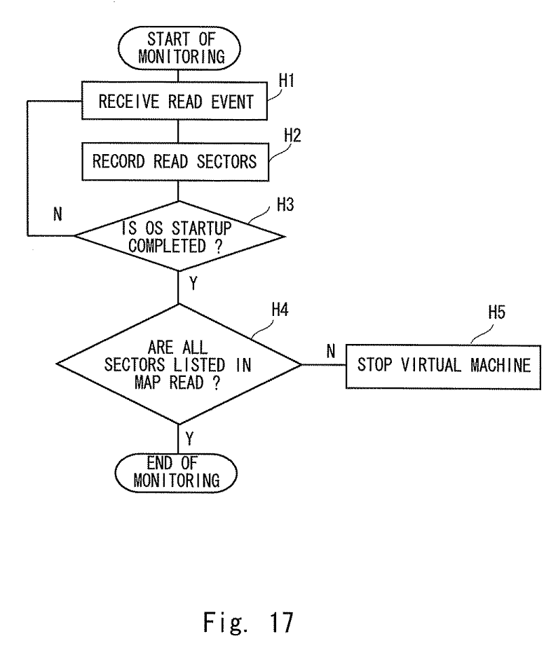

Operations of a read event check (step W2) are explained in detail with reference to a flowchart of FIG. 17. The input/output monitoring means 112 receives a read event from the virtual machine image execution means 111 (step H1). Next, the input/output monitoring means 112 records read sectors in the storage unit (step H2). Then, it confirms whether the startup of the OS is completed (step H3), and if it not completed, the process returns to the step H1. When the process returns from the step H3 to the step H1, it stands ready in the step H1 to receive the next read event.

When the startup of the OS has been completed, the input/output monitoring means 112 compares sectors recorded in the step H2 with sectors indicated in the indispensable reading item of the map (step H4). As a result of the comparison, if it is determined that there are sectors that have not been read, the input/output monitoring means 112 considers that bypassing occurs, for example, in a boot sequence, and suspends the virtual machine (step H5). If all the sectors are read, it finishes the read event check (step W2).

This exemplary embodiment can provide the following advantageous effects. That is, a disk map is generated by an administrator by designating files and partitions through the administration UI 109 in a first exemplary embodiment. However, in this exemplary embodiment, the OS and security middleware are executed by the virtual machine image test means 107, and a disk map is generated by the disk map generation means 106 based on the execution state of the virtual machine image test means 107. Therefore, even if there is no administrator or rule-set creator who has extensive knowledge about the OS, a disk map with regard to the write protection item can be generated.

### Exemplary Embodiment 3

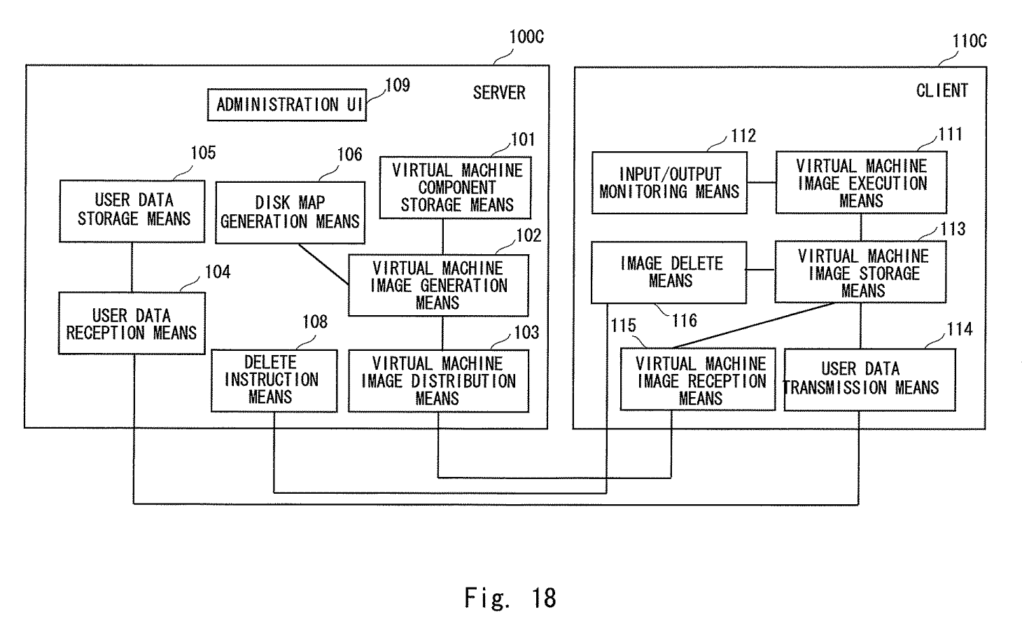

Next, a third exemplary embodiment of the present invention (Embodiment 3) is explained hereinafter with reference to the drawings. FIG. 18 is a block diagram illustrating a configuration of a server 100C and a client 110C in accordance with a third exemplary embodiment. As shown in FIG. 18, it is different from a first exemplary embodiment in that the server 100C includes delete instruction means 108 and the client 110C includes image delete means 116. Note that the same signs are assigned to the same components as those in a first exemplary embodiment, and their detailed explanation is omitted. Further, it is also possible to provide the server 100B in accordance with a second exemplary embodiment shown in FIG. 12 with a delete instruction means 108, and thereby creating a virtual machine operation system wherein such a server and a client 110C cooperate with each other.

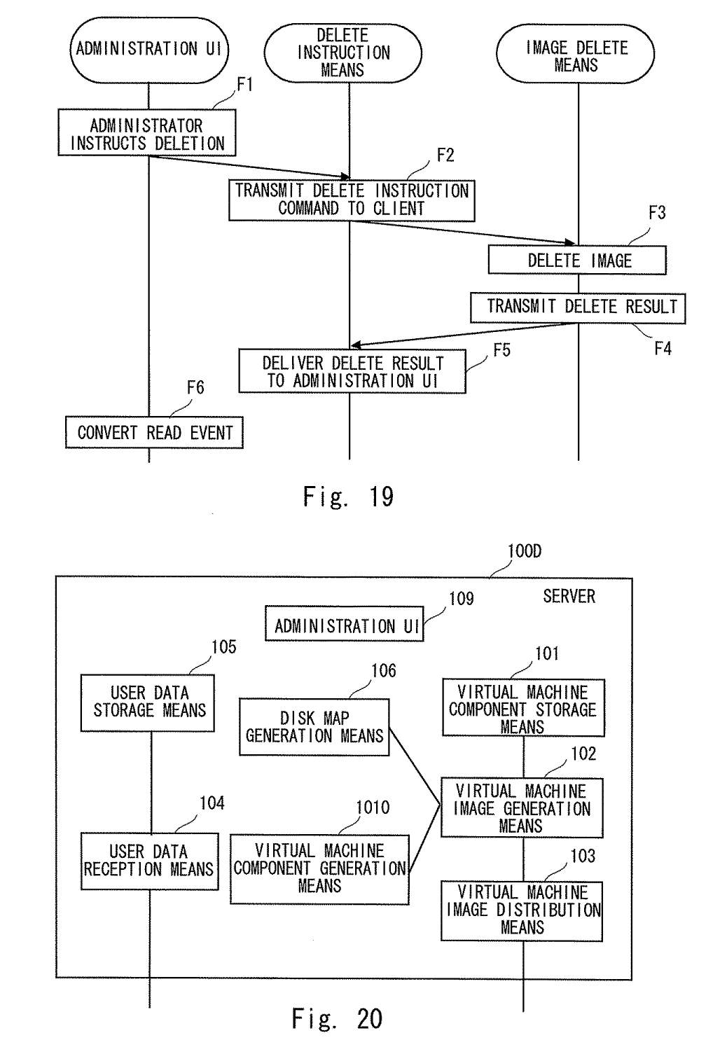

FIG. 19 is a sequence diagram showing operations for deleting a virtual machine image in accordance with a third exemplary embodiment. Operations other than the virtual machine image deletion are the same as those of a first exemplary embodiment.

An administrator instructs the deletion of the virtual machine image by manipulating the administration UI 109 (step F1). All the disk images contained in the virtual machine image may be indicated as the image to be deleted, or a certain disk image such as a user data disk image may be indicated as the image to be deleted. When the deletion of a virtual machine image is instructed, the delete instruction means 108 transmits a massage indicating the image to be deleted to the client 110C (step F2). In the client 110C, the image delete means 116 selects and deletes data in the area to be deleted in response to the massage (step F3). When the deletion is completed, the image delete means 116 transmits a deletion result message to the delete instruction means 108 of the server 100C (step F4). This massage contains information of the failure or success of deletion. The delete instruction means 108 delivers the deletion result to the administration UI 109 (step F5). The administration UI 109 displays the result (step F6). Note that in the process of the step F7, the delete instruction means 108 may generates a log in which the delete event has been recorded.

Since an unnecessary virtual machine image is removed from the client 110C in this exemplary embodiment, the physical disk can be used efficiently. Further, since an administrator can confirm the deletion of a user data disk image in which confidential information is recorded, it can ensure that, even when the client 110C is lost, any possibility of an information leak incident will be eliminated.

Next, a fourth exemplary embodiment is explained hereinafter with reference to the drawings. FIG. 20 is a block diagram illustrating a configuration of a server 100D in accordance with a fourth exemplary embodiment of the present invention. As shown in FIG. 20, the server 100D is different from the server 100 in accordance with a first exemplary embodiment in that the server 100D includes a virtual machine component generation means 1010. The same signs are assigned to the same components as those in a first exemplary embodiment, and their detailed explanation is omitted. Note that the client is the same as the client 110 in a first exemplary embodiment. Further, a virtual machine component generation means 1010 may be also provided in the server 100B in accordance with a second exemplary embodiment shown in FIG. 12 and the server 100C in accordance with a third exemplary embodiment shown in FIG. 18.

In this exemplary embodiment, if no suitable virtual machine image exists in the virtual machine component storage means 101, an administrator generates an OS disk image, a provisioning disk image, or a user data disk image by using the virtual machine component generation means 1010.

Next, operations of this exemplary embodiment are explained hereinafter. If an OS disk image is to be generated, the virtual machine component generation means 1010 first generates a virtual device configuration file in which the configuration of a virtual device is written in response to a manipulation by the administrator. Next, the virtual machine component generation means 1010 generates a virtual machine based on the virtual device configuration file and executes it. Finally, an OS is installed by using an OS-installation CD-ROM or the like.

If a provisioning disk image is to be generated, the virtual machine component generation means 1010 reads an OS disk image and a virtual device configuration file generated in a manner described above and executes a virtual machine. Next, by manipulating the OS on the virtual machine, security middleware is installed through a communication network or a storage medium.

If a user data disk image is to be generated, a blank partition is created and formatted.

In this exemplary embodiment, even if any desirable OS disk image, provisioning disk image, or user data disk image does not exist in the virtual machine component storage means 101 for an administrator, a virtual machine image desirable for the administrator can be generated in the virtual machine image generation means 102 by generating a new disk image.

Note that although an OS disk image is read and a new provisioning disk image is generated in the operations for generating a provisioning disk image, a new provisioning disk image may be generated by making a copy of an already-generated provisioning disk image and installing security middleware in the copied disk image. When operations are carried out in a manner like this, only security middleware that is not installed in the already-generated provisioning disk image needs to be installed.

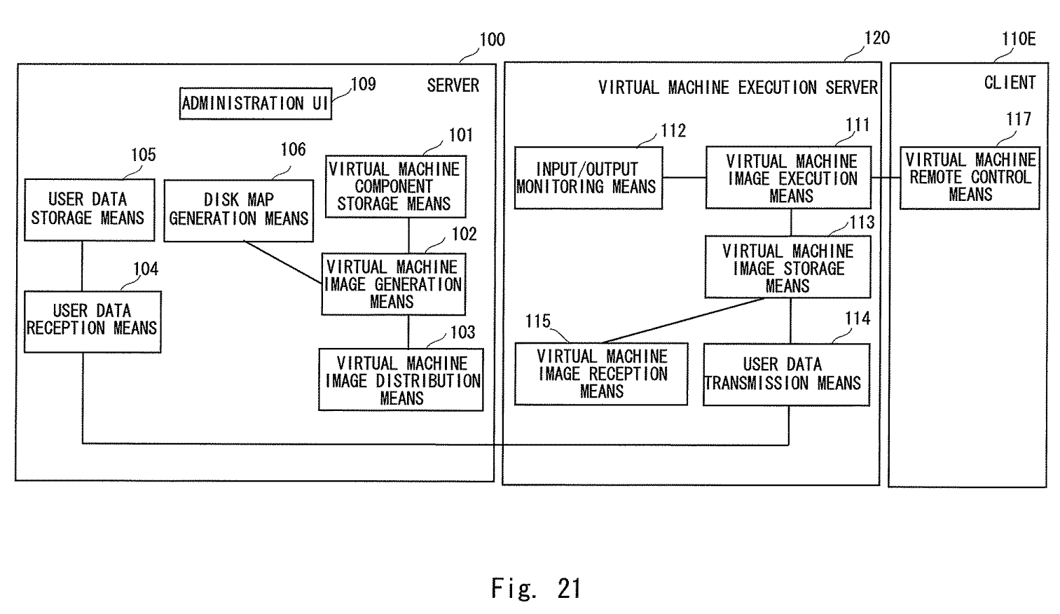

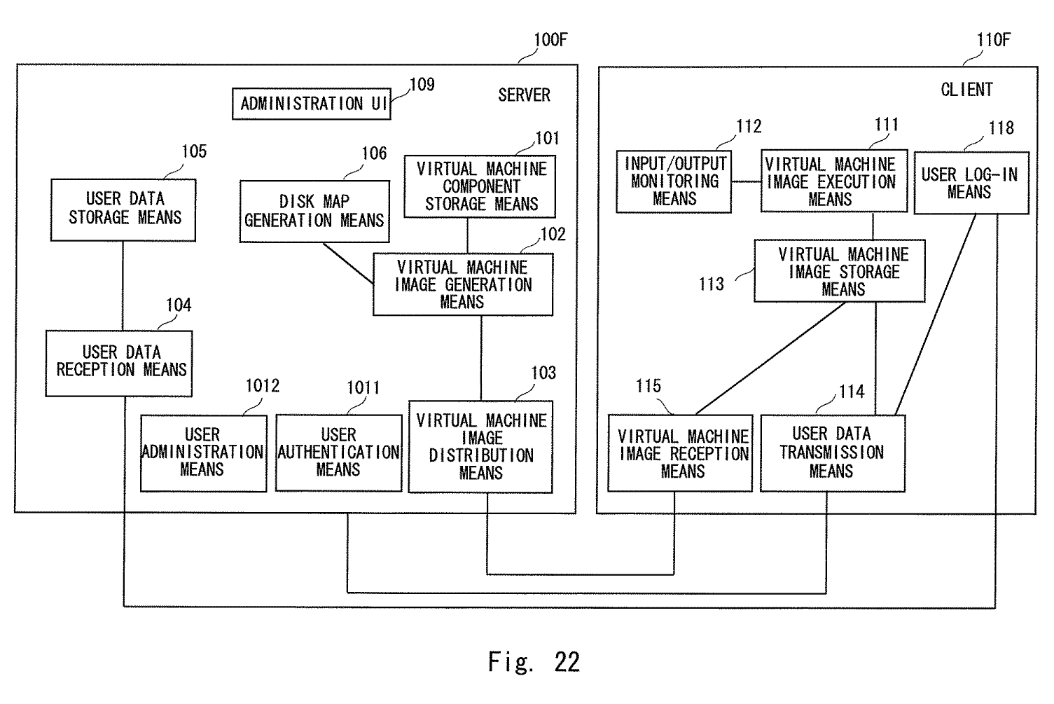

Next, a fifth exemplary embodiment is explained hereinafter with reference to the drawings. FIG. 21 is a block diagram illustrating a configuration of a virtual machine operation system in accordance with a fifth exemplary embodiment of the present invention. As shown in FIG. 21, this exemplary embodiment is different from a first exemplary embodiment in that the virtual machine execution server 120 includes input/output monitoring means 112, virtual machine image execution means 111, virtual machine image storage means 113, user data transmission means 114, and virtual machine image reception means 115, and that the client 110E includes virtual machine remote control means 117. Note that the configurations of the input/output monitoring means 112, the virtual machine image execution means 111, the virtual machine image storage means 113, the user data transmission means 114, and the virtual machine image reception means 115 are same as those possessed by the client 110 in a first exemplary embodiment. Further, as a substitute for the server 100, the server 100B in a second exemplary embodiment shown in FIG. 12, the server 100C in a third exemplary embodiment shown in FIG. 18, or the server 100 in a fourth exemplary embodiment shown in FIG. 20 may be used.

The configuration of the server 100 is similar to that of a first exemplary embodiment. In the client 110E, the virtual machine remote control means 117 is connected with a display (not shown) to display a window of the virtual machine and an input device (not shown) to receive an input from a user. Further, the virtual machine execution server 120 and the client 110E transmit/receive data through a communication network such as the Internet.

In this exemplary embodiment, the virtual machine is executed in the virtual machine image execution means 111 located in the virtual machine execution server 120. The virtual machine remote control means 117 operates in the client 110E, and communicates with the virtual machine image execution means 111. A screen image of the virtual machine is transferred from the virtual machine image execution means 111 to the virtual machine remote control means 117 of the client 110E and displayed in a display of the client 110E. An input from the input device of the client 110E is transferred from the virtual machine remote control means 117 to the virtual machine image execution means 111.

Similarly to first to fourth exemplary embodiments, the virtual machine image generation means 102 generates a virtual machine image, and the disk map generation means 102 generates a disk map in this exemplary embodiment. The distribution of a virtual machine image is also similar to those of first to fourth exemplary embodiments except that the virtual machine image reception means 115 and the virtual machine image storage means 113 operate in the virtual machine execution server 120 instead of in the client 110. Therefore, its explanation is omitted. The collection of user data is also similar to those of first to fourth exemplary embodiments, and therefore its explanation is also omitted.

Next, execution of the virtual machine is explained hereinafter. In comparison with first to fourth exemplary embodiments, only difference is that the location where the input/output monitoring means 112 and the virtual machine image storage means 113 operate is changed from the clients 110 and 110C to the virtual machine execution server 120, but their operations are the same as those of the first to fourth exemplary embodiments.

In addition to the operations in first to fourth exemplary embodiments, the virtual machine image execution means 111 also communicates with virtual machine remote control means 117 in this exemplary embodiment. That is, a screen image of a virtual machine that is being executed in the virtual machine image execution means 111 is transferred to the virtual machine remote control means 117 and displayed in a display of the client 110E. Further, an input from the input device of the client 110E is transferred from the virtual machine remote control means 117 to the virtual machine image execution means 111. A user can operate the virtual machine that is being executed in the virtual machine image execution means 111 located in the virtual machine execution server 120 by remote control in which the input device of the client 110E is manipulated.

This exemplary embodiment has an advantageous effect that in a client system in which a virtual machine is executed in the virtual machine execution server 120 and only screen images are transferred to the client 110E, the OS and security middleware of a virtual machine running in the virtual machine execution server 120 can be protected.

Note that although a configuration in which a server 100 and a virtual machine execution server 120 are separated is shown in this exemplary embodiment, the server 100 and the virtual machine execution server 120 do not necessarily have to be separated and they may be implemented by one server.

### Exemplary Embodiment 6

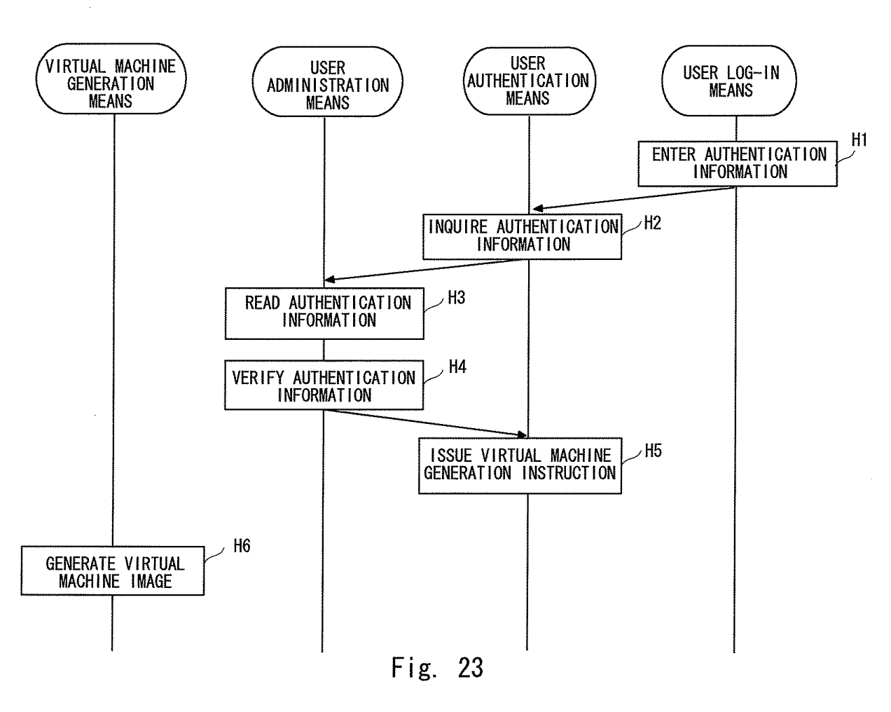

Next, a sixth exemplary embodiment is explained hereinafter with reference to the drawings. FIG. 23 is a block diagram illustrating a virtual machine operation system in accordance with a sixth exemplary embodiment of the present invention. As shown in FIG. 23, this exemplary embodiment is different from a first exemplary embodiment in that the server 100G includes user authentication means 1011 and user administration means 1012, and that the client 110F includes user log-in means 118.

Note that Further, as a substitute for the server 100F, a user authentication means 1011 and a user administration means 1012 may be also provided in the server 100B in accordance with a second exemplary embodiment shown in FIG. 12, the server 100C in accordance with a third exemplary embodiment shown in FIG. 18, and the server 100D in accordance with a fourth exemplary embodiment shown in FIG. 20. Further, a user log-in means 118 may be also provided in the client 110C in accordance with a third exemplary embodiment.

The user log-in means 118 receives authentication information for authenticating a user and transmits it to the user authentication means of the client 110F. The authentication information is a user ID and secret information that is possessed only by the user. The user authentication means 1011 communicates with the user log-in means 118, inquires of the user administration means 1012 about the validity of authentication information, and instructs the virtual machine image generation means 102 to generate a virtual machine. The user administration means 1012, which has a database retaining users and authentication information, determines whether authentication information received from the user authentication means 1011 is valid or not and delivers the result to the user authentication means 1011.

Next, operations of this exemplary embodiment are explained hereinafter. In first to fifth exemplary embodiments of the present invention, an administrator performs instructions for the generation and distribution of a virtual machine by manipulating the administration UI 109. In a sixth exemplary embodiment, a virtual machine is distributed without any instruction from an administrator with a trigger in which a user uses the user log-in means 118 for an authentication process. With regard to the user data collection, the user log-in means 118 also detects the termination of the virtual machine and issues an instruction for the user data transmission to the user data transmission means 114, so that it is also performed without any instruction from an administrator. Further, the virtual machine image generation means 102 distributes different virtual machine images in accordance with the user who logs in the client 110F. Furthermore, the operations for generating a virtual machine image is different between when a user logs in for the first time and when the user logs in for the second time or later.

Firstly, operations at the first log-in are explained hereinafter with reference to a sequence diagram of FIG. 23. A user enters authentication information into the user log-in means 118 (step H1). The authentication information is delivered to the user authentication means 1011. The user authentication means 1011 delivers the authentication information to the user administration means 1012 and inquires whether or not the authentication information is valid (step H2). The user administration means 1012 reads authentication information recorded in the database (step H3). The user administration means 1012 determines whether or not the authentication information received from the user authentication means 1011 matches with authentication information read form the database and thereby confirms whether the authentication information received from the user authentication means 1011 is valid or not, and then notifies the user authentication means 1011 of the result (step H4).

When the user authentication means 1011 receives a result indicating that the authentication information is valid (authentication success), it issues an instruction for generating a virtual machine to the virtual machine image generation means 102 (step H5). The virtual machine image generation means 102, which has disk image combination maps, generates a virtual machine for each user by using a disk image combination map.

A user ID, an OS disk image name, a provisioning disk image name, and a user data disk image name are written in a disk image combination map. That is, it retains information about which disk images should be combined to generate a virtual machine image for a certain user ID. The disk image combination maps are generated in advance by an administrator by using the administration UI 109. A virtual machine image has information about a user ID embedded therein to indicate which user that virtual machine image is created for.

Note that though it is not shown in FIG. 23, if the virtual machine image generation means 102 transmits a result indicating that the authentication information is invalid in the step H4, the user authentication means 1011 notifies the user log-in means 118 of the failure of the authentication, and the process returns to and is repeated from the step H1.

The distribution of the virtual machine image is similar to those of first to fifth exemplary embodiments, and therefore its explanation is omitted.

Next, collection of user data is explained hereinafter. During the virtual machine execution, the user log-in means 118 monitors the virtual machine image execution means 111. When the user log-in means 118 detects the termination of the virtual machine execution, it issues an instruction for the user data to be collected to the user data transmission means 114 based on a disk map stored in the virtual machine image storage means 113.

Next, operations for generating a virtual machine image at a time of the second log-in or later are explained hereinafter. Operations for generating a virtual machine image at the second log-in or later are substantially the same as operations for generating a virtual machine image at the first log-in except that the virtual machine image generation means 102 generates a virtual machine image by reading a user data disk image from the user data storage means 105 instead of reading from the virtual machine component storage means 101. If only a portion of the user data disk image is stored in the user data storage means 105, the missing portion is complemented from a user data disk image stored in the virtual machine component storage means 101.

In this exemplary embodiment, a different virtual machine image can be generated based on the log-in by user without any instruction from an administrator with a trigger in which the user executes the log-in process. Further, the distribution of a virtual machine image and the collection of user data can be also perfumed without any instruction from an administrator by using a log-in process by a user as a trigger. Furthermore, even when the client 110F breaks down or is stolen, data loss can be prevented because user data is recorded in the sever 100F. Furthermore, at the second log-in or later, user data disk image is read from the user data storage means 105, so that the work at the previous log-in can be continued even from a different client from the one the user logged in at the previous log-in.

Note that although a virtual machine image is generated according to the user at a time of log-in by the user in the sixth exemplary embodiment, an administrator may generate a virtual machine image in advance by using the administration UI 109 and the virtual machine image distribution means 103 may distribute the virtual machine image according to the user who loges in the client 110. In such a case, for example, an administrator creates a virtual machine image in advance for a User A by combining an OS disk image A, a provisioning disk image B, and a user data disk image C. Similarly, the administrator also creates a virtual machine image for a User B by combining an OS disk image D, a provisioning disk image E, and a user data disk image F. When the User A logs in by using the user log-in means 118, the user authentication means 1011 instructs the virtual machine image distribution means 103 to distribute the pre-created virtual machine image for the User A.

Further, the user log-in means 118 provides an instruction for the user data to be collected to the user data transmission means 114 in a sixth exemplary embodiment. However, when the client 110F includes the image delete means 116 as in the case of a third exemplary embodiment, the user log-in means 118 may provide an instruction for the deletion to the image delete means 116. When configured in such a manner, no user data is recorded in the client 110F as long as no user logs in, and therefore it gives an advantageous effect that no information leak occurs even if the client 110 is stolen.

Further, although the authentication information is defined as a user ID and secret information that is possessed only by the user in the sixth exemplary embodiment, the authentication information may includes a group ID so that authentication can be performed by using a pair of a user ID and a group ID and secret information possessed by the user. When configured in such a manner, information about which group the user belongs to in addition to the user ID and the secret information possessed by the user are recorded in the database of the user administration means 1012. For example, if a User A belongs to a group X and a group Y, it takes a format “user ID: User A, secret information: XXXX, ID of group to which user belongs: group X/group Y” or a similar format.

Further, when configured in such a manner, a virtual machine image is generated according to the pair of a user ID and a group ID. For example, in a case where a User A belongs to a group X and a group Y, when the User A enters X as a group ID at a log-in process, a virtual machine image for the group X is distributed, and when the User A enters Y as a group ID, a virtual machine image for the group Y is distributed. Therefore, a single user can receive a plurality of virtual machine images. That is, it provides an advantageous effect that a user can use a plurality of virtual machine environments by using different group IDs according to the purpose of use.

Furthermore, a virtual machine image can be generated according solely to the group ID, i.e., without taking the user ID into consideration. In such a case, it has an advantageous effect that a certain virtual machine image is distributed to a certain group, i.e., that the generation of virtual machine images can be controlled on a group-by-group basis.

Further, although user data is automatically collected when the virtual machine execution is finished in a sixth exemplary embodiment, an administrator may select a user ID or a group ID recorded in the database of the user administration means 1012 by using the administration UI 109 so that user data of a certain user ID or a certain group ID is collected.

In such a case, if an administrator selects a user ID or a group ID, or a combination of a user ID and a group ID recorded in the database of the user administration means 1012 by using the administration UI 109, the user administration means 1012 notifies the user data reception means 104 of the selected user ID or group ID, or the combination of a user ID and a group ID. The user data reception means 104 provides an instruction for collecting user data corresponding to the selected user ID or group ID, or the combination of a user ID and a group ID to the user data transmission means of all the clients. If a virtual machine image of that user ID or group ID, or combination of a user ID and a group ID is stored in the virtual machine image storage means 113, the user data transmission means 114 transmits the user data. When configured in such a manner, it has an advantageous effect that user data can be collected according to user administration such as deletion of a user or a group.

Note that, similarly to the case of user data collection, an administrator may delete a virtual machine image of a certain user ID or a certain group ID by selecting a user ID or a group ID recorded in the database of the user administration means 1012 by using the administration UI 109.

Further, in the operations for collecting user data and deleting a virtual machine image, the user administration means 1012 may delete the selected user ID or group ID, or the combination of a user ID and a group ID from the database at the same time as when the user administration means 1012 notifies the user data reception means 104 of the selected user ID or group ID, or the combination of a user ID and a group ID.

Further, if the client 110F includes the delete instruction means 108 and the client 110 includes the image delete means 116 as in the case of a third exemplary embodiment, the user administration means 1012 may notify the delete instruction means 108 of a user ID or a group ID to be deleted and then the delete instruction means 108 may instruct the image delete means 116 of all the client to delete the virtual machine image of the selected user ID or group ID. In such a case, if a virtual machine image of the relevant user ID or group ID is stored in the virtual machine image storage means 113, the image delete means 116 delete the corresponding virtual machine image. Only user data disk image may be deleted, rather than deleting the whole virtual machine image.

### Example 1

Next, specific exemplary examples are explained hereinafter. Firstly, exemplary examples of a first exemplary embodiment are explained hereinafter.

The server 100 is, for example, a typical computer equipped with an input/output interface such as a mouse, a keyboard, and a display, and also equipped with a hard disk. The client 110 is, for example, a desktop type personal computer or a notebook type personal computer.

The virtual machine component storage means 101 stores an OS disk image in which an OS is installed, a provisioning disk image in which an application and security middleware are installed, and a user data disk image in which user data is recorded. In the OS disk image, Windows XP (registered trademark) or Linux (registered trademark), for example, is installed. In the provisioning disk image, antivirus software and word-processing software, for example, are installed as security middleware and an application respectively.

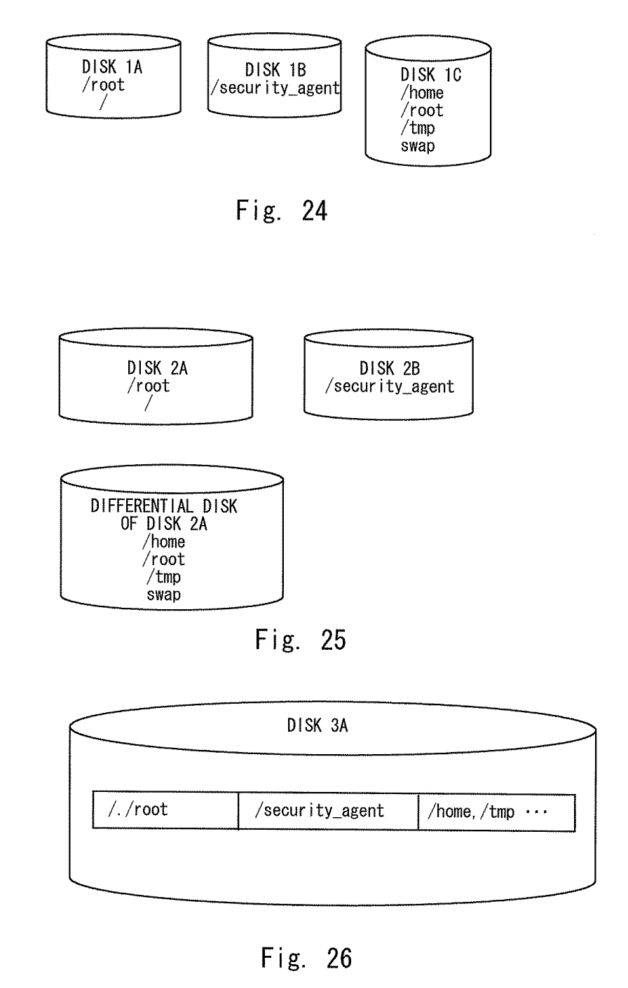

An example of a method for dividing into areas in which the OS, security middleware, and user data are recorded is shown in FIG. 24 in which three independent disks are used. Alternatively, the division may be implemented as two independent disks and their difference as shown in FIG. 25.

The virtual machine image distribution means 103 distributes a virtual machine image through a communication network in response to a request from the virtual machine image reception means 115 of the client 110. The communication mode used in the distribution is, for example, TCP/IP. Further, an encryption protocol such as IPSec and SSL may be incorporated in order to prevent masquerade and wire-tapping, and to detect tampering.

The virtual machine image storage means 113 is, for example, a read/write interface to a hard disk, and the hard disk has sufficient storage capacity to store a virtual machine image.

The virtual machine image execution means 111 reads a virtual device configuration file contained in a virtual machine image and generates virtual devices such as a virtual CPU, a virtual NIC, and a virtual CD-ROM according to it. Further, it also generates a virtual device from the contents of a disk image contained in the virtual machine image.

The input/output monitoring means 112, which is a module to monitor inputs/outputs by the virtual machine image execution means 111, blocks writing to sectors to which writing is prohibited in the disk map when writing to those sectors occurs.

The user data transmission means 114 generates a signature that indicates which physical machine is used as a user data disk image. A TPM, for example, is used for the generation of the signature. Further, it transmits the user data disk image and the signature to the user data reception means through a communication network. The communication mode is, for example, TCP/IP, and an encryption protocol such as IPSec and SSL may be incorporated in order to prevent masquerade and wire-tapping, and to detect tampering.

The user data reception means 104 is a module that checks the validity of the reception of the user data and signature. For example, it checks the validity of the signature by using a public key for the signature of the client.

The user data storage means 105 is a storage medium to store user data and its interface, and the storage medium is, for example, a hard disk.

The administration UI 109 is an interface between an administrator and each means, and is a program capable of issuing an instruction to each means and receiving massages through a GUI or a CUI. The administration UI 109 may be a program running on the OS, or a program running on a browser.

An administrator first selects a virtual device configuration file in which the configuration of a virtual machine is recorded and an OS disk image in which an OS is installed. For example, information such as “memory amount is 500M bytes, the number of network cards is one, USBs are supported” is recorded in the virtual device configuration file. Since only an OS is installed and no application is installed in the OS disk image, it cannot be used for any practical operation on its own.

Next, an administrator selects a provisioning disk image. An application and security middleware are installed in the provisioning disk image. The combination of the OS disk image and the provisioning disk image completes a set of an OS and an application and security middleware. Further, by combining a user data disk image in which user-created data is recorded to it, a virtual machine image usable for a practical operation is completed. For example, a virtual machine image with which Java (registered trademark) can be easily developed can be generated by combining an OS disk image of Windows XP (registered trademark) and a provisioning disk image of Eclipse of a Java (registered trademark) development environment.

As shown in FIG. 24, a virtual disk configuration is divided, for example, to three disks, i.e., a disk 1A, a disk 1B, and a disk 1C are used, and an OS disk image, a provisioning disk image, and a user data disk image are allocated in the disk 1A, disk 1B, and disk 1C respectively, a virtual disk is generated and an area in which user data is recorded is allocated in the user data disk image. In Linux (registered trademark), for example, /home and /root and the like are allocated in the user data disk image. Alternatively, as shown in FIG. 25, a disk configuration may be configured in which an OS is allocated in a disk 2A and a differential disk records difference from the disk 2A is provided.

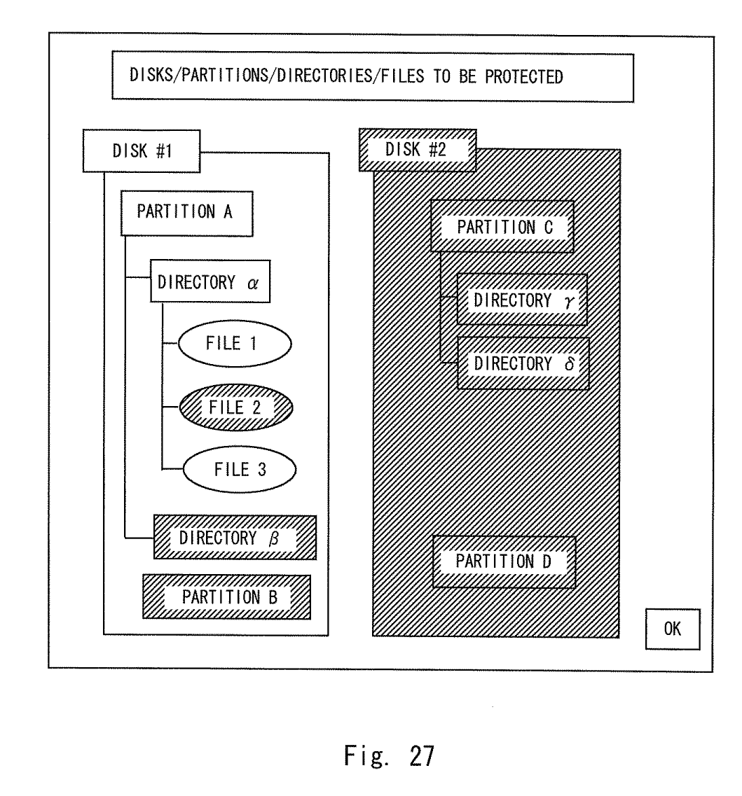

The disk map generation means 106 interprets a disk image in a virtual machine image. That is, the disk map generation means 106 extracts information about disks/partitions/directories/files from the disk image and outputs these information pieces to the administration UI 109. The administration UI 109 displays these information pieces in the display unit. An administrator designates partitions and files that the administrator wants to protect by using the administration UI 109. As an example of a screen image of the display unit, a list of disks/partitions/directories/files is displayed, for example, as shown in FIG. 27. The administrator designates objects to be protected by clicking the display. In the example shown in FIG. 27, a file 2, a directory β, and a partition B in a disk #1, and a disk #2 are designated as the objects to be protected. The disk map generation means 106 acquires which sector the designed partitions, files or the like are recorded in by interpreting the disk image, and writes the acquired sectors in the disk map. By mapping information about which sectors the designated partitions and files and the likes are recorded in based on the interpretation result in this manner, the write protection item of the disk map is generated. For example, in a case where an administrator designates a file 1 of the disk A as a write protection area, if the sectors in which this file is recorded are sectors 12345 to 13000, the disk map generation means 106 adds the sectors 12345 to 13000 to the write protection item like the one shown in FIG. 5.

Similarly, if mapping is performed for the user data collection item, the disk map generation means 106 figures out which sectors disks and partitions are recorded in, and writes the figured-out sectors in the disk map.

The virtual machine image distribution means 103 waits for a request from the virtual machine image reception means 115 of a client, and when a request occurs, it distributes a virtual machine image and a disk map through a communication network. Alternatively, the virtual machine image distribution means 103 may issue a transmission request to the virtual machine image reception means 115, and by doing so, a virtual machine image may be distributed. When the virtual machine image reception means 115 receives a virtual machine image, it checks the virtual machine image storage means 113 as to check whether or not the OS disk image and provisioning disk image of the virtual machine image that is supposed to be distributed already exist in the virtual machine image storage means 113. If they already exist, it notifies the virtual machine image distribution means 103 accordingly. The virtual machine image distribution means 103 distributes only a disk image of the type that does not exist in the client.

After the virtual machine image is distributed, the administrator may update the OS and security middleware and their configuration and the like by re-distributing only the OS disk image and provisioning disk image in a similar operation. The disk image to be distributed may be an independent disk image or a differential disk image for the already-distributed disk image. For example, when an administrator wants to change the configuration of the security middleware, the relevant configuration file in the provisioning disk image is rewritten and the provisioning disk image is distributed to the client 110. The virtual machine image storage means 113 in the client 110 changes the stored provisioning disk image by overwriting it with the distributed provisioning disk image. When it is distributed as a differential disk image, the distributed differential disk image is stored in the virtual machine image storage means 113 in the client 110. Then, the virtual machine image execution means 111 combines and uses those two disk images when the virtual machine is executed.

The virtual machine image execution means 111 generates a virtual disk, a virtual CPU, and a virtual NIC and the like, and executes the virtual machine. The virtual machine image execution means 111 is, for example, Xen or VMWare (registered trademark).

The input/output monitoring means 112 performs monitoring so that the sectors of the OS disk image and the provisioning disk image listed in the disk map are not overwritten, and ensures that the OS and security middleware are not tampered. For example, since writing to the virtual disk is performed based on the type of reading/writing and the sector information, the input/output monitoring means 112 may hooks and monitors them. It compares the hooked read/write command with the disk map, and by doing so, determines whether the command is discarded or not. When the command is discarded, the input/output monitoring means 112 may provide a notice that the blocking was carried out to the administration UI 109 of the server 100 through the communication network. The administrator can check whether or not there is any user who is trying to do illegal conduct by looking at the notification that writing was blocked in the administration UI 109.

When user data is backed up or user data is collected because of the completion of a project, the user data transmission means 114 sends only the user data disk image back to the server 100. The user data transmission means 114 determines which areas of the virtual disk should be collected by referring to the collection item of the disk map. For example, if “user data disk image C” is written, it transmits that disk image.

The user data transmission means 114 generates a signature for user data before transmitting the user data. For example, in the case of a mode using a TPM, the signature is generated by using the signature function of the TPM. A key that cannot be extracted from the TPM is used as a private key to generate the signature. This signature ensures that user data has been certainly used in a physical machine with a TPM.

When the user data reception means 104 receives user data, it checks the signature. For example, in the case of a mode using a TPM, the validity of the signature is checked by a pre-extracted public key of the TPM. If it is valid, the file is delivered to the user data storage means 105. If it is invalid, it causes the administration UI 109 to display a warning.

The user data storage means 105 performs recording in such a manner that the physical machine and the data are associated. For example, by recording a date, the name of a physical machine, and the name of user data, the user data storage means 105 can provides user data promptly to an administrator when he/she wants to confirm the user data.

When the format of the user data that is delivered from the user data reception means 104 is an independent disk format and composed of a single partition, the user data storage means 105 may extract the user data as a file, for example, by mounting it in a loopback device in the case of Linux (registered trademark). In the case of Linux (registered trademark), for example, a disk image called “userdisk.img” can be mounted by issuing the following command.

“mount userdisk.img/mnt-o loop”

When the disk is composed from a plurality of partitions, the relevant partition portion may be cut out and mounted by the command. When the format of user data delivered from the user data reception means 104 is a differential disk image format, the user data storage means 105 makes up the missing portion by combining it with the disk image which is stored in the virtual machine component storage means 10 and from which the differential disk is originated. After the missing portion is complemented, it may be mounted by using the command.

Although a configuration in which an independent disk is uses as the disk in which the user generation is written as shown in FIG. 24 and a configuration in which it is divided as a differential disk as shown in FIG. 25 have been shown as examples, the OS disk image, provisioning disk image, and user data disk image may be combined into a single virtual disk by dividing it into a plurality of partitions.

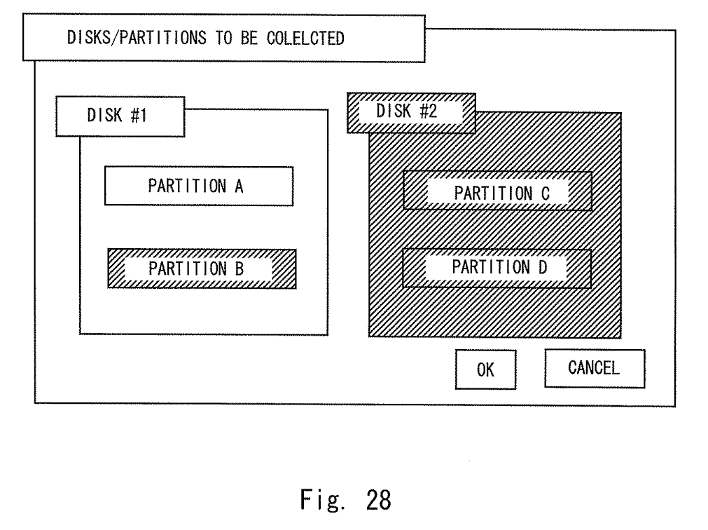

In such a configuration, the user data collection item cannot be designated in disk image units. Therefore, the mapping is generated by designating partitions in a similar manner to the generation of the write protection item. For example, when the /home partition extends from 10000 to 20000 sectors, these 10000 to 20000 sectors are recorded as the collection range in the map. An administrator designates the collection item, for example, by using a screen image by the administration UI 109 as shown in FIG. 28.

When user data is to be collected, the user data is collected by referring to this map. For example, data in the 10000 to 20000 sectors of the virtual disk is taken out as the user data in the above-described example.

### Example 2

Next, exemplary examples of a second exemplary embodiment are explained hereinafter. Explanation for similar portions to those of the first exemplary example is omitted.

As shown in FIG. 12, the server 100B in a second exemplary example of the invention includes virtual machine image test means 107 capable of executing a virtual machine.

In the first exemplary example, the operation in which an administrator designates partitions and files to be protected is shown as an operation for generating a disk map. However, if the administrator has no or little knowledge, the designation is difficult. Therefore, the virtual machine image test means 107 executes a virtual machine in the server 1008, and thereby defines sectors that are read during the execution as write protection sectors. If writing to the disk by the OS is not permitted, the OS may not be able to operate. Therefore, sectors in which writing is performed are removed from the write protection item of the disk map. Since a user log-in window is displayed in Linux (registered trademark) and Windows (registered trademark), any user process is not operated in this state. Therefore, the map may be generated from inputs/outputs occurring from the booting to the display of the log-in window. For example, an administrator confirms that the OS has displayed a log-in window, and completes the generation of the disk map by pressing the disk map generation finish button of the administration UI 109.

In such a configuration, areas that have not been read during the startup and sectors to which the OS performs writing are removed from the write protection item. Therefore, there is a possibility that user data may be mixed in these areas. To prevent user data from being mixed, security middleware that permits writing of user processes only in certain areas is introduced. Furthermore, this security middleware may be protected by a security middleware protection mechanism. This also holds true for a case where security middleware to be protected is designated on a file-by-file basis, rather than on a partition-by-partition basis, by using the administration UI 109.

In file systems such as a FAT, when a file is moved, the file itself is not rewritten, but the FAT table is rewritten instead. Therefore, it is possible to tamper the OS and security middleware by moving files and rewriting sectors at the destination. When files of the OS and security middleware are moved, the OS reads sectors at the destination as those files. Therefore, sectors where the files originally existed are not read. Accordingly, it is possible to detect whether any file is moved or not by monitoring file reading during the OS startup. Therefore, in order to cope with tampering that is carried out by moving files, an indispensable reading map may be generated simultaneously with the generation of the write protection map, and the input/output monitoring means 112 may monitor inputs during the virtual machine execution to confirm that security middleware is read into during the startup.

In the first exemplary embodiment, user data may be stored without any modification or may be extracted and stored as files by interpreting the file system of the partitions. However, when the OS on a virtual machine uses an uncommon file system or other file systems for which their specifications are not open to the public, the interpretation of the file systems may be difficult.

In such cases, to extract user data in the format of a file, an administrator combines the distributed virtual machine image with user data disk image transmitted from the client 110 and causes the virtual machine image test means 107 to execute the virtual machine, so that virtual machine that was running on the client 110 can be reproduced. By taking out a given file from the virtual machine environment of the client 110 and delivering it to the user data storage means 105, user-created data is extracted in the form of a file. As a method of extracting a file from a virtual machine, a COM port communication or a communication using a virtual NIC, for example, is used. Alternatively, writing may be performed on a new virtual disk by using a file system with which both the OS on the virtual machine and the OS of the server 100B can be interpreted, and that disk may be mounted by the OS of the server 1008.

### Example 3

Next, exemplary examples of a third exemplary embodiment are explained hereinafter. Explanation for similar portions to those of the first exemplary example is omitted.

The deletion instruction means 108 in the server 100C shown in FIG. 18 specifies a method and an object to be deleted, and issues an instruction to the image delete means 116 of the client 110C through a communication network. The network protocol between the delete instruction means 108 and the image delete means 116 is, for example, TCP/IP, and an encryption protocol such as IPSec and SSL may be incorporated in order to prevent masquerade and wire-tapping, and to detect tampering.

The entire image or only the user data disk image, for example, is designated as an object to be deleted. Examples of the delete methods include a simple deleting operation and an operation in which overwriting with random data is performed after the deletion.

The image delete means 116 receives an instruction from the image delete means 116 and deletes a disk image from the virtual machine image storage means 113. For example, when the purpose is to merely increase free space in the physical disk, a disk image is deleted by using an “rm” command in Linux (registered trademark). When it is for the countermeasures against information leaks that are carried out by analyzing the hard disk, a disk image is deleted by using an “rm” command and then the sectors in which the disk image was written is overwritten with random values, and thus making the analysis of the hard disk impossible.

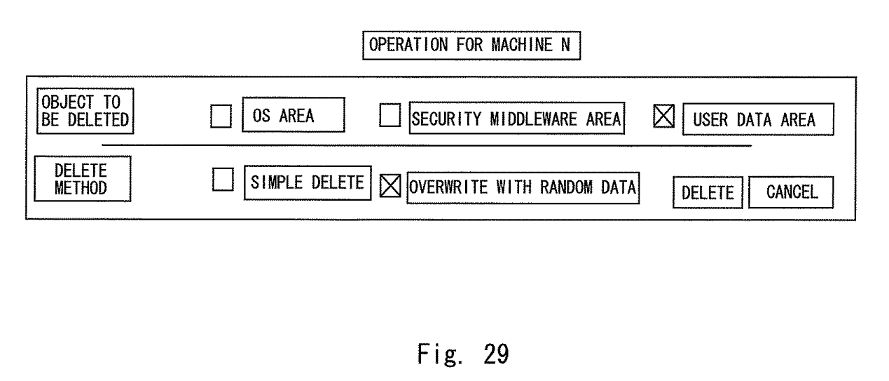

When an image is to be deleted, an administrator instructs it by using the administration UI 109. FIG. 29 shows an example of a screen image by the administration UI 109. In FIG. 29, a user data disk image is designated as an object to be deleted. Furthermore, it also indicates that the delete area should be overwritten with random data when the deletion is carried out.

The administration UI 109 notifies the delete instruction means 108 of an object to be deleted and a delete method specified by the administrator. The delete instruction means 108 transmits the instruction to the image delete means 116. The image delete means 107 deletes a disk image on the physical disk in accordance with the instruction. The image delete means 107 transmits a deletion result based on a network protocol between the delete instruction means 108 and the image delete means 107. For example, if the deletion succeeded, “SUCCESS” is transmitted, and if it did not succeed, a message indicating the failure such as “FAILURE PHYSICAL DISK ERROR” and its reason are transmitted. Upon receiving the result, the delete instruction means 108 notifies the administration UI 109 of the result, and the administration UI 109 displays the result. At this point, the delete instruction means 108 records the date, the disk image to be deleted, the client name, and the result of the deletion as a log. This log can be used for the audit.

### Example 4

Next, exemplary examples of a fourth exemplary embodiment are explained hereinafter. Explanation for similar portions to those of the first exemplary example is omitted.

When an OS disk image is to be newly generated, a virtual device configuration file is first generated by using the virtual machine component generation means 1010 in the server 100D shown in FIG. 20. If an already-existing virtual device configuration file is used, the operation of the virtual machine component generation means 1010 is unnecessary.

Next, the virtual machine image generation means 102 reads the virtual device configuration file, and generates and executes a virtual machine. Note that by allocating an installation disk of Windows (registered trademark), for example, to a virtual CD-ROM, Windows (registered trademark) can be installed.

When a provisioning disk image is to be generated, the virtual machine image generation means 102 reads a virtual device configuration file and an OS disk image generated in the above-described manner, and executes a virtual machine. At this point, a provisioning disk image is newly generated. The provisioning disk image is an independent disk image, or a differential image from the OS disk image. Finally, an administrator installs security middleware in the provisioning disk image by using a communication network or a CD-ROM.

### Example 5

Next, exemplary examples of a fifth exemplary embodiment are explained hereinafter. Explanation for similar portions to those of the first to fourth exemplary examples is omitted.

In this example, the client 110E is, for example, a thin-client equipped with a display and an input device such as a keyboard and a mouse. The virtual machine execution server 120 is, for example, a typical computer equipped with interfaces such as a mouse, a keyboard, and a display, and also equipped with a hard disk.

The network protocol between the virtual machine image execution means 111 and the virtual machine remote control means 117 is, for example, TCP/IP, and an encryption protocol such as IPSec and SSL may be incorporated in order to prevent masquerade and wire-tapping, and to detect tampering.

The virtual machine remote control means 117 receives a screen image of the virtual machine image execution means 111 located in the virtual machine execution server 120 and displays it in a display. For example, in a case where Windows XP (registered trademark) is running on a virtual machine, a screen image of Windows XP (registered trademark) is displayed in the client 110E. An input from the mouse or keyboard of the client 110E is input to the virtual machine remote control means 117 through the virtual machine remote control means 117, and the user manipulates the virtual machine. For example, when a user clicks a mouse connected to the client 110E, the information of the clicking is delivered to the virtual machine image execution means 111 through the virtual machine remote control means 117, and an operation corresponding to the mouse-clicking is executed in the OS on the virtual machine.

### Example 6

Next, exemplary examples of a sixth exemplary embodiment are explained hereinafter. Explanation for similar portions to those of the first to fifth exemplary examples is omitted.

In this example, the user log-in means 118 is implemented, for example, by a program that provides a user with an interface with which the user enters a user ID and a password. The user log-in means 118 may be a device that reads a fingerprint or a device that reads a smart card. The authentication information is, for example, a user ID and a password, information of a fingerprint, or a private key recorded in the smart card. The user authentication means 1011 communicates with the user log-in means 118, and is implemented by a program that inquires of the user administration means 1012 whether the authentication information is valid or not and instructs the virtual machine image generation means 102 to generate a virtual machine. The user administration means 1012 has a database retaining authentication information, and is implemented by a program that determines whether authentication information delivered from the user authentication means 1011 is valid or not.

The user log-in means 118 and the user authentication means 1011 are linked by a communication network, and the network protocol is, for example, TCP/IP. An encryption protocol such as IPSec and SSL may be incorporated in order to prevent masquerade and wire-tapping, and to detect tampering.

Next, operations are explained hereinafter. A user of the client 110F enters authentication information by using the user log-in means 118. For example, when a user ID and a password are entered, the information is delivered to the user authentication means 1011. The user authentication means 1011 delivers the authentication information to the user administration means 1012 and inquires whether the authentication information is valid or not. The user administration means 1012 determines whether or not the user ID and password delivered from the user authentication means 1011 matches with a user ID and a password recorded in the database and thereby determines the validity of the authentication information, and then notifies the user authentication means 1011 of the result. When the result is an authentication failure, the user authentication means 1011 notifies the user log-in means 118 of the authentication failure. The user log-in means 118 prompts the user to re-enter an ID and a password by displaying the input window for an ID and a password again. When it is an authentication success, the user authentication means 1011 issues an instruction for generating a virtual machine image to the virtual machine image generation means 102.

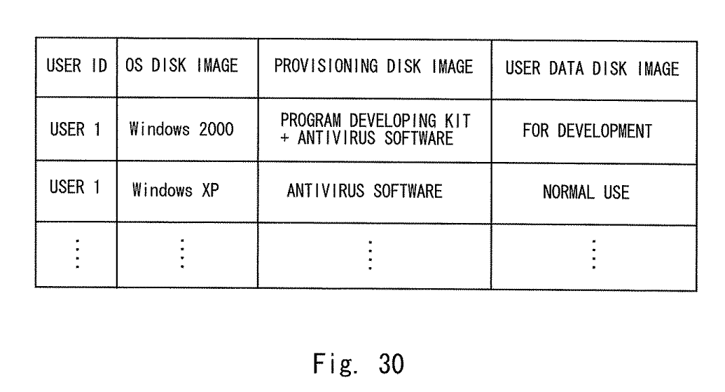

The instruction contains the user ID to identify the user, like an example “to generate a virtual machine image for a user A”. The virtual machine image generation means 102 receives the instruction and generates a virtual machine image. At this point, an administrator specifies in advance which disk images should be combined to generate the virtual machine image by generating a disk image combination map for each user like the one shown in FIG. 30. For example, in a case where the map shown in FIG. 30 is used, when a User 2 succeeded in authentication, a virtual machine image is generated by combining an OS disk image of Windows XP (registered trademark), a provisioning disk image of antivirus software, and an ordinary user data disk image.

The distribution of the virtual machine image is similar to those of the first to fifth exemplary embodiments, and thus its explanation is omitted. The user log-in means 118 monitors the virtual machine image execution means 111, and when the user log-in means 118 detects the termination of the virtual machine, it issues an instruction for collecting user data to the user data transmission means 114. The operations of user data collection are substantially similar to those of the first to fifth exemplary embodiments except that the signature created by the user data transmission means 114 includes, in addition to the data indicating which client the user data belongs to, an user ID indicating which user the data belongs to.

When the client 110F includes the image delete means 116, the user log-in means 118 may delete user data by providing an instruction for the deletion to the image delete means 116. The delete operation is similar to that of the third example, and thus its explanation is omitted.

At the second log-in or later, the virtual machine image generation means 102 reads the user data of the user who logged in from the user data storage means 105 and uses it as a user data disk image. For example, when a user referred to as User 1 logs in the client 110F, the virtual machine image generation means 102 reads the user data of the User 1 from the user data storage means 105 and generates a virtual machine image by using it as a user data disk image. When only a portion of the user data disk image is stored in the user data storage means 105, e.g., when only 5000 sectors constituting a portion of the user data disk image of the User 1 are stored in the user data storage means 105 whereas the user data disk image originally has 10000 sectors, a complete user data disk image is created by making up the remaining 5000 sectors from the user disk disc image stored in the virtual machine component storage means 101, and by doing so, a virtual machine image is generated.

Next, an example in which a virtual machine is generated from the combination of a user ID and a group ID is explained hereinafter. Explanation for operations similar to those in the case where a virtual machine is generated according solely to a user ID is omitted.

A user enters a group ID in addition to a user ID and a password into the user log-in means 118. The entered information is delivered to the user administration means 1012 through the user authentication means 1011, and the user administration means 1012 determines whether or not the user belongs to the group that the user entered into the user log-in means 118, in addition to determining whether the user ID and password are valid or not. If the user does not belong to the group, it notifies the user authentication means 1011 of the authentication failure.

The group ID is added in the disk image combination map, in addition to the user ID, the OS disk image, the provisioning disk image, and the user data disk image. For example, the combination of virtual machine image of a group X of a User 2 is described, for example, as “User 2, group X, OS disk image of Windows XP (registered trademark), provisioning disk image of antivirus software, normal user disk image”.

The user authentication means 1011 issues an instruction for generating a virtual machine image to the virtual machine image generation means 102. The instruction contains the user ID to identify the user and the group ID to identify the group, like an example “to create a virtual machine image for a group X of a user 2”. The virtual machine image generation means 102 determines the combination of disk images by referring to the disk image combination map, so that it can generates a virtual machine according to the combination of a user Id and a group ID.

When a virtual machine image is to be generated according solely to the group ID, the combination is written without specifying any user ID in the disk combination map. For example, it is described as “group X, OS disk image of Windows XP (registered trademark), provisioning disk image of antivirus software, normal user disk image”. An instruction for generating a virtual machine from the user authentication means 1011 to the virtual machine image generation means 102 may be also generated on a group-by-group basis by excluding the user ID, like an example “to create a virtual machine image for a group X”.

Note that an example in which a user enters a group ID into the user log-in means 118 is explained. However, in a system in which each user belongs to only one group, the group is uniquely determined as the user is determined, and therefore the user does not need to enter the group ID into the user log-in means 118.

Next, an example in which an administrator performs user data collection or deletion for a certain user ID or a group ID by using the administration UI 109 is explained hereinafter.

A list of user IDs and a list of group IDs recorded in the database of the user administration means 1012 are displayed in a screen for an administrator. The administrator selects a user ID or a group ID, or a combination of a user ID and a group ID that is to be collected or deleted. Examples of the selected ID include a user A, a group D, or a group X of a user A. Next, the administrator selects the collection or the deletion.

When the administrator selects, for example, the user data collection for a user A, the user data reception means 104 transmits a message “to collect the user data of a user A” to the user data transmission means 114 of all the clients. If a virtual machine image of the user A is stored in the virtual machine image storage means 113, the user data transmission means 114 transmits the user data.

When the administrator selects, for example, the user data deletion for a user A, the user data reception means 104 transmits a message “to delete the user data of a user A” to the image delete means 116 of all the clients. If a virtual machine image of the user A is stored in the virtual machine image storage means 113, the image delete means 116 deletes the user data.

### INDUSTRIAL APPLICABILITY

The present invention can be also used in software outsourcing projects. For example, during the initial stage of a project, an administrator of the party who contracts out the software generates a virtual machine image and distributes it to a client of the party who contracts in the software. During the operation stage of the project, the administrator can prevent information leaks by monitoring the client by security middleware. Further, at the end of the project, they can collect user data, i.e., documents and programs through a communication network.

Further, as another possible example for use, work in an office can be conducted securely in a home. For example, business operations are conducted by transferring a virtual machine image used in the office to a computer in the home. When the business operations are finished, the work is transmitted to the office and the data is deleted.

1. A server device that generates a virtual machine image and distributes the virtual machine image to a second device that executes a virtual machine based on a virtual machine image, the server device comprising:
virtual machine image generation unit that generates a virtual machine image by selecting a disk image area from each of a plurality of pre-created operating system disk image areas, a plurality of pre-created application disk image areas, and a plurality of pre-created user data disk image areas and combining the selected disk image areas; and
virtual machine image distribution unit that distributes the virtual machine image generated by the virtual machine image generation unit to a second device executing a virtual machine based on the virtual machine image.

2. A server device that generates a virtual machine image and distributes the virtual machine image to a second device that executes a virtual machine based on a virtual machine image, the server device comprising:
virtual machine image generation unit that generates a virtual machine image including a disk image area including a data write protection area, and a user data disk image area;
disk map generation unit that generates a disk map capable of specifying the data write protection area; and
virtual machine image distribution unit that distributes a virtual machine image generated by the virtual machine image generation unit and a disk map generated by the disk map generation unit to a second device executing a virtual machine based on the virtual machine image.

3. A server device that generates a virtual machine image and distributes the virtual machine image to a second device that executes a virtual machine based on a virtual machine image, the server device comprising:
virtual machine image generation unit that generates a virtual machine image in such a manner that a user data disk image area and another disk image area are distinguishable;
disk map generation unit that generates a disk map capable of specifying a data collection area in the user data disk image area; and
virtual machine image distribution unit that distributes a virtual machine image generated by the virtual machine image generation unit and a disk map generated by the disk map generation unit to a second device executing a virtual machine based on the virtual machine image.

4. A server device that generates a virtual machine image and distributes the virtual machine image to a second device that executes a virtual machine based on a virtual machine image, the server device comprising:
user authentication unit that authenticates a user of a second device executing a virtual machine based on the virtual machine image;
user administration unit that administers a user ID and secret information for authentication;
virtual machine image generation unit that, when the user authentication unit succeeds in authenticating a user of the second device, generates a virtual machine image by selecting a disk image area from each of a plurality of pre-created operating system disk image areas, a plurality of pre-created application disk image areas, and a plurality of pre-created user data disk image areas and combining the selected disk image areas in accordance with the user of the second device; and
virtual machine image distribution unit that distributes the virtual machine image generated by the virtual machine image generation unit to the second device.

5. (canceled)

6. (canceled)

7. The server device according to claim 1, further comprising delete instruction unit that transmits a massage to a second device to which the virtual machine image distribution unit distributed a virtual machine image, the massage indicating a delete instruction by specifying a disk image in the second device.

8. (canceled)

9. A client device that receives a distribution of a virtual machine image and a disk map from a server device that generates the virtual machine image and the disk map, and executes a virtual machine based on the virtual machine image, the virtual machine image including a disk image area including a data write protection area and a user data disk image area, the disk map being capable of specifying a data write protection area, the client device comprising:
virtual machine image reception unit that receives a virtual machine image and a disk map, the virtual machine image including a disk image area including a data write protection area and a user data disk image area, the disk map being capable of specifying a data write protection area;
virtual machine image execution unit that executes a virtual machine based on a virtual machine image distributed from the server device; and
input/output monitoring unit that specifies a data write protection area in the disk map, monitors a write event by the virtual machine image execution unit, and prohibits data writing to the data write protection area.

10. A client device that receives a distribution of a virtual machine image and a disk map from a server device that generates the virtual machine image and the disk map, and executes a virtual machine based on a virtual machine image, the virtual machine image being generated in such a manner that a user data disk image area and another disk image area are distinguishable, and the disk map being capable of specifying a data collection area in the user data disk image area, the client device comprising:
virtual machine image reception unit receiving distribution of a visual machine image and a disk map, the virtual machine image being generated in such a manner that a user data disk image area and another disk image area are distinguishable, the disk map being capable of specifying a data collection area in the user data disk image area;
virtual machine image execution unit that executes a virtual machine based on a virtual machine image distributed from the virtual machine image distribution unit; and
user data transmission unit that transmits data in a data collection area specified in the disk map to the server device.

11. (canceled)

12. A client device that receives a distribution of a virtual machine image and a disk map from a server device that generates the virtual machine image and the disk map, and executes a virtual machine based on a virtual machine image, the virtual machine image being generated in such a manner that an operating system disk image area, an application disk image area, and a user data disk image area are distinguishable, and the disk map being capable of specifying a data write protection area, the client device comprising:
virtual machine image reception unit receiving distribution of a visual machine image and a disk map, the virtual machine image being generated in such a manner that an operating system disk image area, an application disk image area, and a user data disk image area are distinguishable, the disk map being capable of specifying a data collection area in the user data disk image area;
virtual machine image execution unit that executes a virtual machine based on a virtual machine image distributed from the virtual machine image distribution unit: and
image delete unit that deletes a disk image in response to reception of a delete instruction specifying the disk image.

13. (canceled)

14. (canceled)

15. A virtual machine operation system comprising:
a server device that generates a virtual machine image and distributes the virtual machine image to a second device that executes a virtual machine based on a virtual machine image, wherein
the server device comprises:
virtual machine image generation unit that generates a virtual machine image by selecting a disk image from each of a plurality of pre-created operating system disk image areas, a plurality of pre-created application disk image areas, and a plurality of pre-created user data disk image areas are and combining the selected disk image areas; and
virtual machine image distribution unit that distributes the virtual machine image generated by the virtual machine image generation unit to the second device, and
the second device comprises virtual machine image execution unit that executes a virtual machine based on the virtual machine image distributed from the virtual machine image distribution unit.

16. A virtual machine operation system comprising:
a server device that generates a virtual machine image and distributes the virtual machine image to a second device that executes a virtual machine based on a virtual machine image, wherein
the server device comprises:
virtual machine image generation unit that generates a virtual machine image including a disk image area including a data write protection area and a user data disk image area;
disk map generation unit that generates a disk map capable of specifying the data write protection area; and
virtual machine image distribution unit that distributes a virtual machine image generated by the virtual machine image generation unit and a disk map generated by the disk map generation unit to the second device, and
the second device comprises:
virtual machine image execution unit that executes a virtual machine based on the virtual machine image distributed from the virtual machine image distribution unit; and
input/output monitoring unit that specifies a data write protection area in the disk map, monitors a write event by the virtual machine image execution unit, and prohibits data writing to the data write protection area.

17. A virtual machine operation system comprising:
a server device that generates a virtual machine image and distributes the virtual machine image to a second device that executes a virtual machine based on a virtual machine image, wherein
the server device comprises:
virtual machine image generation unit that generates a virtual machine image in such a manner that a user data disk image area and another disk image area are distinguishable;
disk map generation unit that generates a disk map capable of specifying a data collection area in the user data disk image area; and
virtual machine image distribution unit that distributes a virtual machine image generated by the virtual machine image generation unit and a disk map generated by the disk map generation unit to the second device, and
the second device comprises:
virtual machine image execution unit that executes a virtual machine based on the virtual machine image distributed from the virtual machine image distribution unit; and
user data transmission unit that transmits data in the data collection area specified in the disk map to the server device.

18. (canceled)

19. A virtual machine operation system comprising:
a server device that generates a virtual machine image and distributes the virtual machine image to a second device that executes a virtual machine based on a virtual machine image, wherein
the server device comprises:
user authentication unit that authenticates a user of the second device;
virtual machine image generation unit that, when the user authentication unit succeeds in authenticating a user of the second device, generates a virtual machine image by selecting a disk image from each of a plurality of pre-created operating system disk image areas, a plurality of pre-created application disk image areas, and a plurality of pre-created user data disk image areas and combining the selected disk image areas in accordance with the user of the second device; and
virtual machine image distribution unit that distributes a virtual machine image generated by the virtual machine image generation unit to the second device, and
the second device comprises virtual machine image execution unit that executes a virtual machine based on the virtual machine image distributed from the virtual machine image distribution unit.

20. (canceled)

21. (canceled)

22. The virtual machine operation system according to any one claim 15, wherein
the server device further comprises delete instruction unit that transmits a massage to the second device to which the virtual machine image distribution unit distributed a virtual machine image, the massage indicating a delete instruction by specifying a disk image in the second device, and
the second device further comprises image delete unit that deletes that disk image in response to reception of a message indicating a delete instruction.

23. (canceled)

24. (canceled)

25. (canceled)

26. A virtual machine operation system comprising:
a server device that generates a virtual machine image and distributes the virtual machine image to a second device that executes a virtual machine based on a virtual machine image, wherein
the server device comprises:
virtual machine image generation unit that generates a virtual machine image by selecting a disk image area from each of a plurality of pre-created operating system disk image areas, a plurality of pre-created application disk image areas, and a plurality of pre-created user data disk image areas and combining the selected disk image areas; and
virtual machine image distribution unit that, when a user logs in the second device, distributes a virtual machine image generated by the virtual machine image generation unit to the second device in accordance with a user ID or a group ID, or a combination of a user ID and a group ID, and
the second device comprises virtual machine image execution unit that executes a virtual machine based on the virtual machine image distributed from the virtual machine image distribution unit.

27. (canceled)

28. (canceled)

29. (canceled)

30. (canceled)

31. A virtual machine operation method in which a server device generates a virtual machine image and distributes the virtual machine image to a second device that executes a virtual machine based on a virtual machine image, wherein
the server device generates a virtual machine image by selecting a disk image area from each of a plurality of pre-created operating system disk image areas, a plurality of pre-created application disk image areas, and a plurality of pre-created user data disk image areas and combining the selected disk image areas,
the server device distributes the generated virtual machine image to the second device, and
the second device executes a virtual machine based on the virtual machine image distributed from the server device.

32. A virtual machine operation method in which a server device generates a virtual machine image and distributes the virtual machine image to a second device that executes a virtual machine based on a virtual machine image, wherein
the server device generates a virtual machine image including a disk image area including a data write protection area and a user data disk image area,
the server device generates a disk map capable of specifying the data write protection area,
the server device distributes the generated virtual machine image and disk map to the second device,
the second device executes a virtual machine based on the virtual machine image distributed from the server device, and
the second device specifies a data write protection area in the disk map, monitors a write event during the virtual machine image execution, and prohibits data writing to the data write protection area.

33. A virtual machine operation method in which a server device generates a virtual machine image and distributes the virtual machine image to a second device that executes a virtual machine based on a virtual machine image, wherein
the server device generates a virtual machine image in such a manner that a user data disk image area and another disk image area are distinguishable,
the server device generates a disk map capable of specifying a data collection area in the user data disk image area,
the server device distributes the generated virtual machine image and disk map to the second device,
the second device executes a virtual machine based on the virtual machine image distributed from the server device, and
the second device specifies a data collection area in the disk map and transmits data in the data collection area to the server device.

34. A virtual machine operation method according to claim 33, wherein the second device monitors execution of a virtual machine image, and instructs transmission of data in the data collection area at the end of virtual machine execution.

35. A virtual machine operation method in which a server device generates a virtual machine image and distributes the virtual machine image to a second device that executes a virtual machine based on a virtual machine image, wherein
the server device authenticates a user of the second device,
when the authentication of the user of the second device succeeds, the server device generates a virtual machine image by selecting a disk image area from each of a plurality of pre-created operating system disk image areas, a plurality of pre-created application disk image areas, and a plurality of pre-created user data disk image areas and combining the selected disk image areas in accordance with the user of the second device,
the server device distributes the generated virtual machine image to the second device, and
the second device executes a virtual machine based on the virtual machine image distributed from the second device.

36. The virtual machine operation method according to claim 32, wherein the server device defines an area specified by information entered through the user interface unit as a data write protection area.

37. (canceled)

38. (canceled)

39. (canceled)

40. (canceled)

41. The virtual machine operation method according to claims 31, wherein
a function of the second device is carried out by a virtual machine execution server communicatively connected to the sever device through a communication network, and
a virtual machine that is being executed by the virtual machine execution server is operated from a client device by remote control.

42. A virtual machine operation method in which a server device generates a virtual machine image and distributes the virtual machine image to a second device that executes a virtual machine based on a virtual machine image, wherein
the server device generates a virtual machine image by selecting a disk image area from each of a plurality of pre-created operating system disk image areas, a plurality of pre-created application disk image areas, and a plurality of pre-created user data disk image areas and combining the selected disk image areas,
when a user logs in the second device, the server device distributes the generated virtual machine image to the second device in accordance with a user ID or a group ID, or a combination of a user ID and a group ID, and
the second device executes a virtual machine based on the virtual machine image distributed from the server device.

43. (canceled)

44. A virtual machine operation method in which a server device generates a virtual machine image and distributes the virtual machine image to a second device that executes a virtual machine based on a virtual machine image, wherein
the server device generates a virtual machine image in accordance with a user ID or a group ID, or a combination of a user ID and a group ID in such a manner that a user data disk image area and another disk image area are distinguishable,
the server device generates a disk map capable of specifying a data collection area in the user data disk image area,
the server device distributes the generated virtual machine image and disk map to the second device,
the second device executes a virtual machine based on the virtual machine image distributed from the server device,
the server device instructs user data collection by specifying a user ID or a group ID, or a combination of a user ID and a group ID, and
when the second device receives an instruction for user data collection, if a virtual machine image corresponding to a relevant user ID or group ID, or combination of a user ID and a group ID is retained, the second device specifies a data collection area in the disk map and transmits data in the data collection area to the sever device.

45. A virtual machine operation method in which a server device generates a virtual machine image and distributes the virtual machine image to a second device that executes a virtual machine based on a virtual machine image, wherein
the server device generates a virtual machine image by selecting a disk image area from each of a plurality of pre-created operating system disk image areas, a plurality of pre-created application disk image areas, and a plurality of pre-created user data disk image areas and combining the selected disk image areas in accordance with a user ID or a group ID, or a combination of a user ID and a group ID,
the server device distributes the generated virtual machine image to the second device,
the second device executes a virtual machine based on the virtual machine image distributed from the server device,
the server device issues a delete instruction by specifying a user ID or a group ID, or a combination of a user ID and a group ID, and
when the second device receives a delete instruction of a virtual machine image, if a virtual machine image corresponding to a relevant user ID or group ID, or combination of a user ID and a group ID is retained, the second device deletes a virtual machine image or a user data disk image.

46. (canceled)

47. A computer-readable medium storing a virtual machine image distribution program that causes a server device that generates a virtual machine image and distributes the virtual machine image to a second device that executes a virtual machine based on a virtual machine image, to execute:
a process of generating a virtual machine image by selecting a disk image area from each of a plurality of pre-created operating system disk image areas, a plurality of pre-created application disk image areas, and a plurality of pre-created user data disk image areas and combining the selected disk image areas; and
a process of distributing the generated virtual machine image to the second device.

48. A computer-readable medium storing a virtual machine image distribution program that causes a server device that generates a virtual machine image and distributes the virtual machine image to a second device that executes a virtual machine based on a virtual machine image, to execute:
a process of generating a virtual machine image including a disk image area including a data write protection area and a user data disk image area;
a process of generating a disk map capable of specifying the data write protection area; and
a process of distributing the generated virtual machine image and disk map to the second device.

49. A computer-readable medium storing a virtual machine image distribution program that causes a server device that generates a virtual machine image and distributes the virtual machine image to a second device that executes a virtual machine based on a virtual machine image, to execute:
a process of generating a virtual machine image in such a manner that a user data disk image area and another disk image area are distinguishable;
a process of generating a disk map capable of specifying a data collection area in the user data disk image area; and
a process of distributing the generated virtual machine image and disk map to the second device.

50. A computer-readable medium storing a virtual machine execution program that causes a client device that receives a distribution of a virtual machine image including a disk image area including a data write protection area and a user data disk image area, and a disk map capable of specifying a data write protection area from a server device that generates the virtual machine image and the disk map, and executes a virtual machine based on the virtual machine image, to execute:
a process of executing a virtual machine based on a virtual machine image distributed from the server device; and
a process of specifying a data write protection area in the disk map, monitoring a write event by the virtual machine image execution unit, and prohibiting data writing to the data write protection area.

51. A computer-readable medium storing a virtual machine execution program that causes a client device that receives a distribution of a virtual machine image and a disk map from a server device that generates the virtual machine image and the disk map, and executes a virtual machine based on a virtual machine image, the virtual machine image being generated in such a manner that a user data disk image area and another disk image area are distinguishable, and the disk map being capable of specifying a data write protection area, to execute:
a process of executing a virtual machine based on a virtual machine image distributed from the server device; and
a process of specifying a data collection area in the disk map and transmitting data in the data collection area to the server device.

52. A computer-readable medium storing a virtual machine execution program that causes a client device that receives a distribution of a virtual machine image and a disk map from a server device that generates the virtual machine image and the disk map, and executes a virtual machine based on a virtual machine image, the virtual machine image being generated in such a manner that an operating system disk image area, an application disk image area, and a user data disk image area are distinguishable, and the disk map being capable of specifying a data write protection area, to execute:
a process of executing a virtual machine based on a virtual machine image distributed from the server device; and
a process of deleting a disk image in response to reception of a message that indicates a delete instruction by specifying the disk image.

53. A computer-readable medium storing a virtual machine image distribution program that causes a server device that generates a virtual machine image and distributes the virtual machine image to a second device that executes a virtual machine based on a virtual machine image, to execute:
a process of generating a virtual machine image by selecting a disk image area from each of a plurality of pre-created operating system disk image areas, a plurality of pre-created application disk image areas, and a plurality of pre-created user data disk image areas and combining the selected disk image areas in accordance with a user ID or a group ID, or a combination of a user ID and a group ID; and
a process of distributing the generated virtual machine image to the second device.

54. The computer-readable medium storing the virtual machine image distribution program according to claim 48, for further executing:
a process of receiving a virtual machine image and executing a virtual machine, and
a process of monitoring an event, and when a read event occurs, defining an area to be read by the read event as a data write protection area.

55. (canceled)

56. A computer-readable medium storing a virtual machine execution program that causes a client device that receives a distribution of a virtual machine image and a disk map from a server device that generates the virtual machine image and the disk map, and executes a virtual machine based on a virtual machine image, the virtual machine image being generated in such a manner that a user data disk image area and another disk image area are distinguishable, and the disk map being capable of specifying a data write protection area, to execute:
a process of executing a virtual machine based on a virtual machine image distributed from the server device; and
a process of specifying a data collection area in the disk map and transmitting data in the data collection area to the server device at the end of virtual machine execution.

57. A computer-readable medium storing a virtual machine execution program that causes a client device that receives a distribution of a virtual machine image and a disk map from a server device that generates the virtual machine image and the disk map, and executes a virtual machine based on a virtual machine image, the virtual machine image being generated in such a manner that an operating system disk image area, an application disk image area, and a user data disk image area are distinguishable, and the disk map being capable of specifying a data write protection area, to execute:
a process of executing a virtual machine based on a virtual machine image distributed from the server device; and
a process of deleting the disk image at the end of virtual machine execution.

58. A computer-readable medium storing a virtual machine execution program that causes a client device that receives a distribution of a virtual machine image and a disk map from a server device that generates the virtual machine image and the disk map, and executes a virtual machine based on a virtual machine image, the virtual machine image being generated in such a manner that a user data disk image area and another disk image area are distinguishable, and the disk map being capable of specifying a data write protection area, to execute:
a process of executing a virtual machine based on a virtual machine image distributed from the server device; and
a process of, in response to reception of a massage that indicates user data collection by specifying a user ID or group ID, or combination of a user ID and a group ID, if a virtual machine image corresponding to a user ID or group ID, or combination of a user ID and a group ID is retained, specifying a data collection area in the disk map and transmitting data in the data collection area to the sever device.

59. A computer-readable medium storing a virtual machine execution program that causes a client device that receives a distribution of a virtual machine image and a disk map from a server device that generates the virtual machine image and the disk map, and executes a virtual machine based on a virtual machine image, the virtual machine image being generated in such a manner that an operating system disk image area, an application disk image area, and a user data disk image area are distinguishable, and the disk map being capable of specifying a data write protection area, to execute:
a process of executing a virtual machine based on a virtual machine image distributed from the server device; and
a process of, in response to reception of a massage that indicates a delete instruction by specifying a user ID or group ID, or combination of a user ID and a group ID, if a virtual machine image corresponding to a user ID or group ID, or combination of a user ID and a group ID is retained, deleting the disk image.

60. A computer-readable medium storing a virtual machine image distribution program that causes a server device that issues an instruction to a second device that executes a virtual machine based on a virtual machine image, to execute a process of instructing user data collection or disk image deletion by specifying a user ID or group ID, or combination of a user ID and a group ID.

61. The computer-readable medium storing the virtual machine image distribution program according to claim 60, for further executing a process of deleting a user ID or a group ID, or a combination of a user ID and a group ID from a database for authentication simultaneously with an instruction to a second device that executes virtual machine based on a virtual machine image.

62. (canceled)
